(19) United States
(12) Patent Application Publication
(10) Pub. No.: US 2026/0284534 A1
(43) Pub. Date: Sep. 24, 2026

(54) SYSTEM

(71) Applicant: SoftBank Group Corp., Tokyo (JP)

(72) Inventor: Seiya YAMAZAKI, Tokyo (JP)

(73) Assignee: SoftBank Group Corp., Tokyo (JP)

(21) Appl. No.: 19/568,868

(22) Filed: Mar. 17, 2026

(30) Foreign Application Priority Data
Mar. 19, 2025 (JP) 2025-045266

(51) Int. Cl. A63F 13/65; A63F 13/67; A63F 13/822

(52) U.S. Cl. CPC A63F 13/65; A63F 13/67; A63F 13/822

(57) ABSTRACT

A system includes a processor that is configured to use a prompt to instruct a generative AI model to transplant past match information and a persona of a real-life expert into the generative AI model, use a prompt to instruct initiation of a match based on user input so that a user can play a board game with an admired expert at any time, and use a prompt to instruct recognition of an emotional state of the user and adjustment of at least one of a difficulty level of the match and a persona of an opponent in accordance with the emotional state of the user.

### CROSS-REFERENCE TO RELATED APPLICATION

This application is based on and claims priority under 35 USC 119 from Japanese Patent Application No. 2025-045266 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional board game systems and AI-based game engines generally provide static or limited interactivity with virtual opponents that lack individualized expert characteristics and do not adapt to a user's emotional state. Even when past match records of real-life experts are available, existing systems do not effectively transplant both the strategic tendencies and the persona of such experts into a generative AI model in a way that allows a user to feel as if they are playing against an admired expert at any time. Furthermore, current systems typically fail to recognize and react to a user's emotional state during game play, resulting in a non-personalized experience in which the difficulty level and opponent personality remain fixed or only crudely adjustable. Additionally, there is insufficient utilization of ongoing match data between a user and an AI opponent to continuously refine and update the emulated expert persona. In particular, there is a need for a system that (i) uses prompts to control a generative AI model so as to embed real experts' past match information and personas, (ii) initiates matches on demand based on user input, (iii) dynamically adjusts difficulty level and opponent persona in response to the user's emotional state, and (iv) accumulates and uses match data to update the expert persona and deploy appropriate strategies according to the game selected by the user.

### SUMMARY

To solve the foregoing problems, a system is provided that comprises a processor configured to operate in conjunction with a generative AI model and a user interface. The processor is configured to use a prompt to instruct the generative AI model to transplant past match information and a persona of a real-life expert into the generative AI model, thereby enabling the generative AI model to emulate both the strategic behavior and personality characteristics of the expert. The processor is further configured to use a prompt to instruct initiation of a match based on user input, such that a user can start a board game session with an emulated expert opponent at any desired time. In addition, the processor is configured to use a prompt to instruct recognition of an emotional state of the user, for example by processing inputs such as user interaction patterns, physiological signals, or explicit feedback, and to adjust at least one of a difficulty level of the match and a persona of an opponent in accordance with the recognized emotional state, thereby providing a personalized and adaptive game experience. The processor is also configured to accumulate match data between the user and the generative AI model and to adjust parameters of the generative AI model based on the accumulated match data so as to update the persona of the expert over time. Moreover, the processor is configured to use a prompt to instruct the generative AI model to develop an appropriate strategy in accordance with a game selected by the user, thereby allowing the same framework to support multiple types of board games while maintaining expert-specific strategic characteristics.

The term “system” refers to an arrangement including at least one processor, memory, and any associated hardware or software components configured to execute the functions described in the claims.

The term “processor” refers to any hardware device or combination of hardware devices capable of executing instructions, including but not limited to a central processing unit (CPU), a graphics processing unit (GPU), a digital signal processor (DSP), a microcontroller, or a combination thereof.

The term “generative AI model” refers to a machine learning or artificial intelligence model that is configured to generate outputs such as moves, strategies, or responses based on learned patterns from training data, including but not limited to neural network models, transformer-based models, or other generative models.

The term “prompt” refers to data, text, or structured instructions provided to the generative AI model that specify or constrain the behavior of the generative AI model, including instructions to load, apply, or modify expert information, personas, strategies, or game-related parameters.

The term “real-life expert” refers to a human player or professional who has actually participated in board game matches in the real world, and whose past match data and persona characteristics can be collected and used to configure the generative AI model.

The term “past match information” refers to data representing previous games or matches played by a real-life expert, including but not limited to move sequences, game states, game results, time usage, annotations, and any associated metadata.

The term “persona” refers to a set of characteristics representing the style, tendencies, preferences, behavior patterns, and personality attributes of a real-life expert as expressed in game play and related metadata, which can be emulated by the generative AI model.

The term “transplant” refers to the process of embedding, encoding, or incorporating past match information and persona of a real-life expert into the generative AI model such that the model's outputs reflect the expert's style and characteristics.

The term “user” refers to any person who interacts with the system to play a board game, provide input, receive output, or otherwise use the functions of the system.

The term “match” refers to a single game or game session of a board game played between the user and an opponent, where the opponent may be controlled by the generative AI model configured to emulate a real-life expert.

The term “board game” refers to any game played on a discrete board or grid with defined rules and legal moves, including but not limited to shogi, chess, go, and other similar games.

The term “initiation of a match” refers to the process of starting a new game session in response to user input, including setting up an initial board state, selecting an opponent persona, and enabling subsequent moves between the user and the AI opponent.

The term “emotional state of the user” refers to a psychological or affective condition of the user, such as stress, frustration, engagement, boredom, excitement, or calmness, which can be inferred or determined from user inputs, behavior, physiological signals, or explicit feedback.

The term “difficulty level of the match” refers to a parameter controlling the strength, accuracy, or challenge level of the AI opponent, including but not limited to search depth, randomness of move selection, or use of suboptimal strategies.

The term “opponent” refers to the entity playing against the user in a match, which in the context of the system is controlled by the generative AI model configured to emulate the persona and style of a real-life expert.

The term “accumulate match data” refers to the process of recording and storing data generated during matches between the user and the AI opponent, including but not limited to move sequences, outcomes, timestamps, and any derived statistics.

The term “parameters of the generative AI model” refers to adjustable values within the generative AI model, such as weights, biases, or configuration variables, that determine how the model processes inputs and generates outputs.

The term “update the persona of the expert” refers to the process of modifying the internal representation of the expert's style and characteristics within the generative AI model based on newly accumulated match data, so that the emulated persona evolves over time.

The term “game selected by the user” refers to a particular board game type or variant that the user chooses to play, such as a specific board game title, rule set, or time control, which determines the rules and strategies that the generative AI model should apply.

The term “appropriate strategy” refers to a sequence or pattern of moves, plans, or decisions generated by the generative AI model that is suitable for the selected game and consistent with the rules of the game, and optionally consistent with the persona of the emulated expert.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

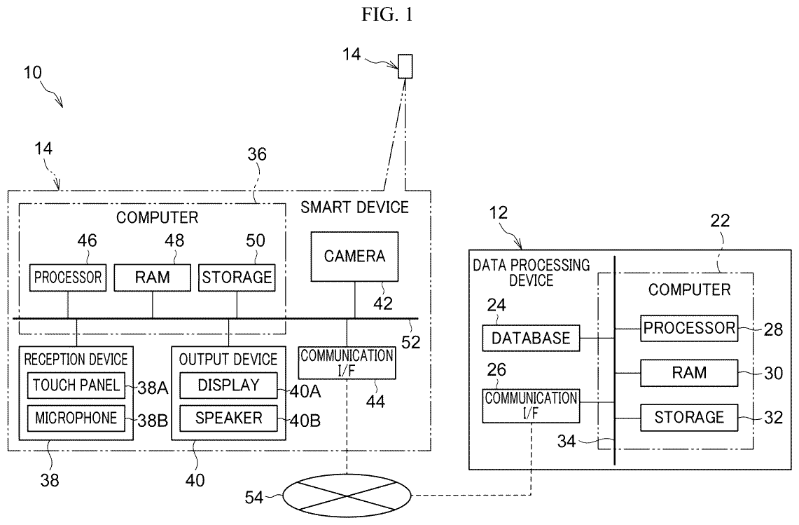

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

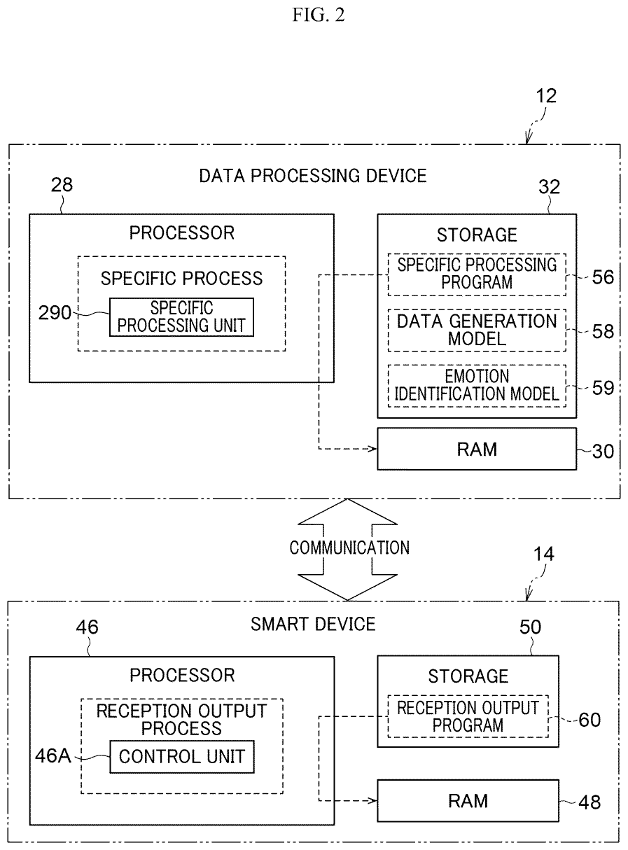

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional game server systems that provide computerized opponents for board-type games typically rely on fixed search engines or static heuristic evaluation functions. Such systems are generally configured to optimize move strength according to predesigned algorithms and do not flexibly adapt their playing style, explanation behavior, or difficulty level in response to user input expressed in natural language. As a result, several technical problems arise in the context of computer-implemented interactive training and analysis environments.

First, existing systems lack an integrated mechanism for systematically collecting past competition information and behavioral characteristics of real-world high-skill individuals, converting such heterogeneous data into a machine-usable representation, and training a unified generative AI model that can condition its move generation on both a current game state and a style specification. In many implementations, game records, textual commentary, and personality descriptors are stored in separate silos or used only for offline analysis, not as real-time control inputs to the move-generation pipeline. This limits the system's ability to generate moves that not only are strong according to a game engine but also are consistent with a desired expert-like style specified at inference time.

Second, conventional systems do not provide a robust computer-implemented mechanism for dynamically controlling a generative AI model by means of user-specified prompt sentences that describe playing style, strategy preference, game type, or difficulty, and for binding such natural-language instructions to a numeric style representation that directly affects the internal inference behavior of the model. As a result, even when a language-capable model is present, the linkage between textual prompts and the low-level move selection logic is ad hoc, non-transparent, or limited to coarse-grained configuration, thereby constraining fine-grained control over the system's behavior.

Third, known systems that log game histories between users and AI opponents commonly store only basic move sequences and game results. They rarely implement an automated, engine-driven classification pipeline that uses evaluation metrics to categorize each move into excellent, poor, or clever moves over large volumes of user-AI battle data.

Consequently, there is no technically integrated feedback loop that feeds aggregated analysis results back to update model parameters or style representations in a way that refines the modeled behavioral characteristics of the high-skill individuals and improves the AI's realism and pedagogical value over time.

Fourth, many current solutions are tightly bound to single game engines or single game types, and do not provide a generalized architecture in which a server can, based on content of a prompt sentence, automatically select among multiple generative AI models or model configurations corresponding to different board-type games, difficulty levels, or strategic profiles. This lack of a modular selection mechanism reduces scalability and makes it difficult to deploy a unified platform supporting multiple games and varying user skill levels without substantial manual reconfiguration.

Accordingly, there is a need for an improved computer-implemented system that (i) acquires and structures competition and behavioral data of high-skill individuals, (ii) trains and serves a generative AI model that conditions move generation on both game state and prompt-derived style signals, (iii) uses prompt sentences as a technical control interface to dynamically adjust model behavior, (iv) records detailed battle history data and performs systematic engine-based evaluation and classification of moves, and (v) uses such data and classifications to iteratively update model parameters or style representations, thereby enhancing the system's ability to provide expert-like, explainable, and adaptable opponents and to generate high-quality feedback to real-world experts.

The specific processing by the specific processing unit 290 of the data processing device 12 in Example 1 is realized by the following means.

The present invention provides a server comprising a processor configured to collect, via a communication network, past competition information and behavioral characteristics associated with high-skill individuals, convert the collected information into structured data, and store the structured data in a storage device; to train, using a machine learning framework and computation resources, a generative AI model that receives board-game state information and style information as input and outputs move distributions and evaluation values, based on the structured data, and to hold the trained generative AI model in a state usable as an opponent that imitates strategies and thinking patterns of the high-skill individuals; to receive, from a terminal device, style instruction information including a prompt sentence and current game state information, convert the prompt sentence into numerical style information by text embedding or keyword extraction, generate model input data by integrating the numerical style information with the current game state information, and input the model input data to the generative AI model so as to cause the generative AI model to generate a move among legal moves in accordance with a style indicated by the prompt sentence; to transmit response data including the generated move and explanation text indicating a reason for selection of the generated move to the terminal device, and to store user moves, model moves, prompt sentences, game state information, and game results as battle history data in the storage device; and to analyze the battle history data by using an evaluation function or an external analysis engine so as to classify each move into an excellent move, a poor move, or a clever move based on changes in evaluation values, and to update parameters or style representations of the generative AI model in accordance with the battle history data and classification results. This enables a technical improvement in computer-based game servers by providing a unified, prompt-controllable generative AI architecture that adaptively generates expert-style moves and explanations, systematically evaluates and classifies move quality at scale, and iteratively refines model behavior based on accumulated battle history, thereby enhancing the effectiveness, flexibility, and realism of AI opponents and feedback functionalities.

The term “system” refers to an arrangement of one or more information processing devices, storage devices, communication interfaces, and terminal devices that cooperate to execute the functions described in the claims.

The term “processor” refers to one or more hardware processing units, such as a central processing unit or a graphics processing unit, that execute instructions to perform data processing, model training, inference, communication control, and storage control.

The term “storage device” refers to one or more non-transitory computer-readable media, such as semiconductor memory, magnetic storage, or optical storage, that store programs, structured data, battle history data, and model parameters.

The term “terminal device” refers to a user-operated computing device, such as a personal computer, a tablet device, or a mobile communication device, that presents a game screen, receives user input, and communicates with the server.

The term “communication network” refers to a wired or wireless data communication infrastructure, including local area networks and wide area networks, that enables data exchange between the server and one or more terminal devices or external information sources.

The term “high-skill individual” refers to a person who has achieved a high level of performance, expertise, or ranking in a competitive activity, such as a board-type game, and whose competition behavior is used as a reference for modeling.

The term “competition information” refers to data representing past competitive activities of a high-skill individual, including game records, move sequences, results, time information, and contextual metadata of matches.

The term “behavioral characteristics” refers to attributes describing tendencies of a high-skill individual, including playing style, risk preference, favored strategies, and patterns of decision making in competitive situations.

The term “structured data” refers to data that has been organized into a machine-usable format, such as records, fields, tables, tensors, or labeled feature sets, suitable for storage, retrieval, and processing by computer programs.

The term “board-type game” refers to a game in which two or more players interact over a discretized playing field represented by cells or positions, such as a board or grid, and move pieces or tokens according to predefined rules.

The term “game state information” refers to data representing a current configuration of a board-type game, including positions of pieces or tokens, turn information, rule-related state, and move history needed to determine legal moves.

The term “generative AI model” refers to a machine-learned model, such as a neural network, that generates outputs including move distributions, evaluation values, or natural language text, in response to input data characterizing a game state and style information.

The term “machine learning framework” refers to a software platform providing functions for defining, training, and executing machine-learned models, including support for tensor operations, optimization algorithms, and hardware acceleration.

The term “computation resources” refers to hardware resources used to execute processing related to data analysis, training, and inference of machine-learned models, including processors, memory, and accelerators.

The term “move distribution” refers to a representation of probabilities or preference scores assigned by the generative AI model to one or more candidate moves in a given game state.

The term “evaluation value” refers to a numeric metric output by a model or engine, indicating an expected outcome, advantage, or quality of a game state or move, such as a score or win probability.

The term “style information” refers to data that encodes a playing style, strategic tendency, difficulty level, or behavioral preference, used as a conditioning signal for the generative AI model.

The term “style instruction information” refers to data received from a terminal device that contains a prompt sentence and optionally other parameters, specifying a desired playing style, strategy, or difficulty for the generative AI model.

The term “prompt sentence” refers to a character string in a natural language that instructs the generative AI model regarding playing style, game type, strategy preference, difficulty, or other behavioral constraints to be reflected in move generation.

The term “numerical style information” refers to a numeric representation, such as a vector or tensor, obtained by processing a prompt sentence or other style-related text, and used as input to the generative AI model.

The term “text embedding” refers to processing that converts a character string, such as a prompt sentence, into a numerical representation that preserves semantic features of the text for use in machine learning models.

The term “keyword extraction” refers to processing that identifies one or more relevant terms or phrases from a prompt sentence or other text, and represents them in a form suitable for controlling the behavior of the generative AI model.

The term “model input data” refers to data constructed for input to the generative AI model, including at least game state information and numerical style information integrated into a single representation.

The term “legal move” refers to a move that is permitted under the rules of the board-type game in a given game state, as determined by a rule engine or game logic.

The term “response data” refers to data transmitted from the server to the terminal device, including a generated move, explanation text, and optionally additional metadata for updating the game screen.

The term “explanation text” refers to natural language text that describes a reason, intention, or strategic consideration behind a move selected by the generative AI model.

The term “battle history data” refers to stored data representing one or more completed or ongoing games between a user and the generative AI model, including move sequences, game states, prompt sentences, and results.

The term “evaluation function” refers to a computational function that takes a game state or move as input and outputs an evaluation value indicating the relative advantage, disadvantage, or quality associated with the input.

The term “external analysis engine” refers to an analysis program or system, separate from the generative AI model, that evaluates game states or moves and provides numeric scores or suggested moves for assessment.

The term “excellent move” refers to a move that, according to an evaluation function or external analysis engine, maintains or significantly improves an evaluation value in a given game state.

The term “poor move” refers to a move that, according to an evaluation function or external analysis engine, significantly worsens an evaluation value in a given game state.

The term “clever move” refers to a move that appears neutral or temporarily unfavorable by a local evaluation metric but leads to a favorable evaluation or strategic advantage in subsequent play, as determined by analysis over multiple subsequent positions.

The term “feedback information” refers to information generated from analysis of battle history data, including classifications of moves and statistical summaries, that is intended to inform a high-skill individual or a system about strengths and weaknesses of modeled behavior.

The term “parameters of the generative AI model” refers to adjustable numerical values, such as weights and biases of a neural network, that determine the output behavior of the generative AI model.

The term “style representation” refers to a portion of the generative AI model or associated data structure that encodes style-related features influencing move generation or explanation behavior.

The term “learning process” refers to processing that adjusts parameters or style representations of the generative AI model using battle history data, feedback information, or other training data, typically by optimization algorithms.

The term “model configuration” refers to a selection or arrangement of one or more model components, architectures, or parameter sets used to perform inference for a particular game type, difficulty level, or strategic profile.

The term “target game” refers to a specific type of board-type game selected for play, as indicated by user input or a prompt sentence, for which a corresponding generative AI model or model configuration is used.

In one embodiment, a server implements the claimed system by executing a program on one or more processors. The server comprises at least one central processing unit (CPU), optional graphics processing units (GPUs) with hardware support for parallel numerical computation, a main memory, a non-transitory storage device, and a network interface. The server executes an operating system such as a general-purpose server operating system and runs application software including a web server, an application server, and machine learning frameworks such as TensorFlow or PyTorch. The server communicates with one or more terminal devices operated by users via a communication network using protocols such as HTTP over TCP/IP.

The server acquires past competition information and behavioral characteristics of high-skill individuals from external information sources. The server executes a data acquisition program that uses a scripting language runtime, for example a Python runtime environment, together with a network access library and a markup parsing library such as a generic HTTP client library and a general-purpose HTML parsing library. The server issues network requests to external web sites and databases, receives markup documents, and parses those documents to extract game records, textual commentary, and personality-related descriptions. The server converts raw game record text into a normalized record structure, for example a sequence of tuples including move index, piece identifier, origin coordinate, destination coordinate, and optional annotation. The server stores such sequences in relational database tables or key-value stores, and stores behavioral descriptors as tags or documents associated with each high-skill individual.

The server performs data preprocessing in order to transform the acquired information into structured data suitable for machine learning. The server removes duplicate game records by computing hash values for normalized move sequences and comparing hash values to detect redundancy. The server standardizes metadata such as player identifiers, time controls, and event identifiers into canonical forms. The server converts each game position into a numeric feature tensor. In one example, the server encodes a board-type game position as a three-dimensional tensor whose first dimension indexes feature channels, whose second and third dimensions correspond to board coordinates, and whose channel values indicate presence and type of pieces, side to move, or rule-related status. The server also converts behavioral characteristics and personality descriptors into style vectors, for example by mapping tags such as “aggressive,” “defensive,” or “positional” to one-hot vectors or low-dimensional embeddings.

The server constructs training datasets for a generative AI model from those feature tensors and style vectors. The server defines, for each recorded move, an input sample that consists of a board-state tensor and a corresponding style vector, and defines a label that indicates the expert-selected move. The server creates batches of such samples and stores them in on-disk dataset formats optimized for sequential loading, such as binary record files that contain serialized tensors and labels. The server records dataset metadata including version information, data ranges, and preprocessing parameters so that later training or evaluation can be reproduced.

The server trains a generative AI model by executing a training program on the processors and GPUs. The generative AI model comprises a neural network architecture that receives concatenated board-state features and style embeddings and outputs both a probability distribution over candidate moves and a scalar evaluation value. In one example, the server defines a model including: an input embedding layer for board features, an input embedding layer for style vectors, one or more transformer blocks or residual convolutional blocks that integrate board and style information, a policy head that applies a linear transformation and softmax activation to produce move probabilities, and a value head that applies a linear transformation and activation function to produce a scalar evaluation. The server initializes model parameters with random values or pre-trained values and defines a loss function that combines cross-entropy loss between predicted move distributions and expert moves with mean squared error loss between predicted evaluation values and target outcomes.

The server executes a training loop in which the server repeatedly loads batches of training data, performs forward propagation through the neural network on GPUs, computes the combined loss, performs backpropagation to calculate gradients, and updates model parameters using an optimization algorithm such as stochastic gradient descent or Adam. The server monitors training metrics including training loss and validation accuracy, and adjusts hyperparameters such as learning rate or batch size in response to those metrics. The server periodically stores model checkpoints that include parameter values and optimizer state to the storage device. This training process yields a generative AI model that produces move distributions that statistically approximate the move preferences of the high-skill individuals while being conditioned on style information.

The server further trains or fine-tunes a natural language generation module to produce explanation text. The server uses game commentary and expert interview text as training data. The server tokenizes such text into subword units and trains a sequence model, such as a transformer-based language model, to predict sequences of tokens given context including game state summaries and selected moves. The server stores the parameters of this language model and configures an inference pipeline in which the move-generation module supplies a description of the selected move and relevant features, and the language model generates a short explanation in natural language.

The server exposes one or more network-accessible interfaces so that terminal devices can initiate and control games. The server implements application-layer endpoints that allow creation of a game session associated with a specific high-skill individual and a specific game type. When a terminal sends a session creation request, the server allocates a session identifier, sets an initial board state, and associates a particular generative AI model instance or configuration corresponding to the selected game. The server stores this association in a memory-based session store and optionally in persistent storage, so that subsequent requests referencing the session identifier can retrieve the current game state and model configuration.

The terminal presents user interfaces for game interaction. The terminal includes a display unit, an input unit such as a touchscreen or pointing device, a communication module, and a local processor. The terminal executes an application that draws a graphical representation of a board-type game on the display, including pieces, grid, and auxiliary information such as turn indicator and move history. The terminal detects user input events such as taps or drag operations and interprets these events as move instructions. The terminal performs basic validation where feasible, such as restricting selections to valid board coordinates.

The terminal also presents a text input field in which a user can enter a prompt sentence. The prompt sentence may contain style preferences, game-type instructions, or difficulty level specifications. Examples of prompt sentences include “Play aggressively like a famous attacking professional and sacrifice material for initiative,” “Play safely and avoid tactical complications, like a solid defender,” and “Please imitate an early king attack strategy and prioritize direct attacks on my king.” The terminal transmits the prompt sentence and current game state information to the server using a structured message, together with the session identifier.

The server receives the prompt sentence and game state information from the terminal via the network interface. The server converts the game state into the internal board-state tensor representation. The server converts the prompt sentence into numerical style information with a text embedding or keyword extraction algorithm. In one example, the server applies a pre-trained tokenization process and passes token indices through an embedding layer and one or more transformer encoder layers to produce a fixed-length style embedding. In another example, the server extracts specific keywords indicating aggression, defense, opening preference, or endgame focus, and maps those keywords to respective style dimensions in a style vector. The server normalizes or scales the style vector and concatenates it with the board-state tensor or injects it via feature-wise modulation into intermediate layers of the generative AI model.

The server then performs inference using the generative AI model. The server inputs the combined board and style representation to the neural network on a GPU. The neural network computes hidden representations through the defined layers, produces a raw score vector for candidate moves, and applies a softmax function to produce a move distribution over legal moves. The server applies a mask that excludes illegal moves according to the rules of the game, using a rule engine module that enumerates legal moves from the current state. The server may then select a move using a deterministic strategy such as choosing the move with maximum probability, or a stochastic strategy such as sampling according to the distribution with a specified temperature parameter. The server thereby generates a move whose statistical characteristics reflect both the high-skill individual's historical behavior and the style indicated by the prompt sentence.

The server optionally generates explanation text describing the reason for the selected move. The server constructs a context representation including a description of the current position, the selected move, and the style vector. The server feeds this context to the language model and uses a decoding algorithm, such as beam search or top-k sampling, to generate a sequence of tokens representing a natural language explanation. For example, the language model may output text such as “I bring the queen out early to apply direct pressure on your king side while exploiting the weaknesses around your king.” The server sends both the selected move and the explanation text to the terminal.

The terminal receives the move and explanation text. The terminal updates the graphical board state by moving the corresponding piece from the source coordinate to the destination coordinate, using rendering primitives to animate or redraw the board. The terminal displays the explanation text in a dedicated area, such as a text panel below the board. The user can thus observe not only the move choice but also model-generated reasoning aligned with the modeled high-skill individual's style.

The server continuously records detailed battle history data. For each move, the server stores the session identifier, move index, player identifier (user or model), the move notation, the board-state hash or a compact representation of the position, the evaluation value if any, and the prompt sentence that was in effect at the time of the move. The server accumulates this data for many sessions and persists it in the storage device. The server also stores final game outcomes, durations, and possibly user identifiers, subject to privacy controls.

The server performs post-game analysis using an evaluation function or an external analysis engine. The server selects completed games and, for each position and move, calls an external engine via an application programming interface or a command invocation. The external engine computes evaluation scores for positions before and after each move. The server calculates differences between those scores to determine whether a move improved, maintained, or degraded the evaluation. The server classifies moves into categories such as excellent, poor, or clever according to thresholds and time-dependent patterns. For example, a move that leads to a temporary evaluation decrease but subsequent long-term improvement may be classified as a clever move. The server aggregates such classifications across games to produce statistical summaries that indicate characteristic strengths and weaknesses of the generative AI model when emulating a given high-skill individual.

The server uses the battle history data and classification results to perform further learning. In one embodiment, the server performs fine-tuning of the generative AI model by adding an auxiliary loss term that encourages the model to align with moves labeled as excellent and to reduce the probability of moves labeled as poor. In another embodiment, the server adjusts style representation parameters so that prompt sentences that emphasize precision or safety reduce the probability of moves previously classified as poor or excessively speculative. The server thus creates a feedback loop in which classification results derived from large-scale user interaction data directly inform parameter updates. This leads to improved move-quality prediction and a closer alignment between requested styles and actual inference behavior.

The described configuration provides several technical effects. By representing both board positions and natural-language prompt sentences as numeric tensors and integrating them into a single model input, the server enables a generative AI model to adjust its behavior based on high-dimensional style information in real time. This integration reduces the need for separate rule-based style controllers and decreases system complexity. Because the server uses GPUs and optimized tensor operations, the model can process input and produce moves with low latency, which improves user experience and makes the system suitable for interactive applications.

Moreover, the server improves prediction accuracy and stylistic consistency through continuous learning driven by classified battle history data. The use of external engines for fine-grained evaluation allows the server to identify specific patterns of error or strength that would not be evident from raw win-loss statistics alone. Adjusting model parameters based on those patterns reduces blunders and increases the frequency of strong or clever moves over time. The server's internal data structures and training pipeline are organized such that repeated analysis and retraining can be performed efficiently at scale.

The system also improves data management and communication efficiency. Because the server stores structured tensors and compact session states rather than entire raw markup documents, the amount of data transmitted to and from the terminal is minimized. The terminal transmits only prompt sentences and compact move or state descriptors, and the server reconstructs full game states internally. This reduces network bandwidth usage and increases throughput. The server's database schema, which separates static expert data from dynamic battle history, allows for efficient indexing and retrieval for analysis queries and training data construction.

The described architecture differs from simple automation of human tasks. A human instructor could not feasibly compute move distributions over all legal moves conditioned on fine-grained style vectors, nor perform large-scale evaluation and classification across thousands of games in real time. The neural network architecture and feedback-based training enable the server to discover non-trivial patterns, including clever tactics and complex style interactions, that emerge from computation over high-dimensional spaces. The server thereby implements a technical improvement in the functioning of computer-based game servers, including more efficient inference paths, more accurate style-conditioned predictions, and more effective use of past data for model refinement.

Multiple variations of the embodiment are possible. The server may employ different neural architectures, such as convolutional neural networks, graph neural networks, or hybrid architectures that combine convolutional layers for local pattern recognition with transformer layers for global context. The server may use different loss function combinations or regularization strategies, such as label smoothing, dropout, or weight decay, to improve generalization. The server may change the way prompt sentences are processed, for example by using a separate pre-trained language encoder and freezing or fine-tuning its parameters.

The server may also support different board-type games by implementing game-specific encoders and rule engines while sharing a common style-conditioning and inference framework.

The terminal embodiments may also vary. A terminal may be implemented as a mobile application, a desktop application, or a web-based client, provided that it can display a board, accept moves and prompt sentences, and communicate with the server. The user may issue prompt sentences at the beginning of a game or dynamically during play to adjust style or difficulty. Such prompt-driven control can be combined with user interface elements such as sliders or toggles that map to specific style dimensions, which the server interprets and incorporates into style vectors in the same pipeline as text-derived features.

By configuring the server and terminal in the described manner, the system implements the claimed invention in a way that is reproducible by a person skilled in the art, and yields practical technical benefits in terms of improved model control, analysis capability, and computational efficiency when providing expert-style, generative AI opponents for board-type games.

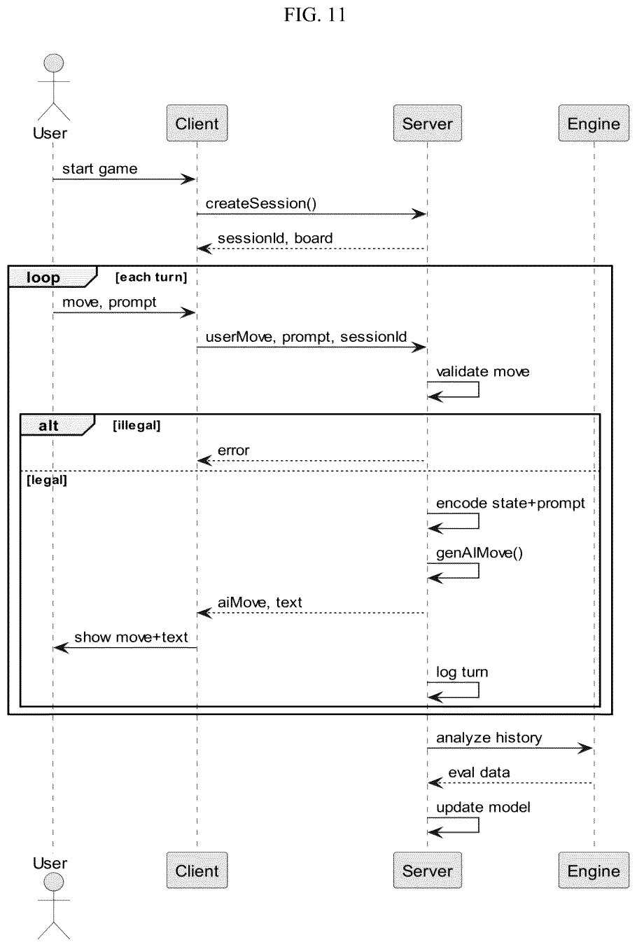

The following describes the processing flow using FIG. 11.

### Step 1:

The server acquires expert-related raw data.

The server receives, as input, identifiers of high-skill individuals and game-type information, for example name strings and game categories. The server issues HTTP requests to external information sources using a network access library, receives HTML or structured documents, and parses those documents to extract game records, commentary text, and personality descriptions. The server converts each raw document into an intermediate representation, such as plain text lines and parsed tables. The server outputs a collection of raw game records and associated text segments for each high-skill individual.

### Step 2:

The server normalizes game records and behavioral descriptions.

The server receives, as input, the raw game records and text segments from Step 1. The server removes markup tags, splits game records into individual moves, and maps piece symbols and board coordinates into a canonical internal notation. The server computes hash values of normalized move sequences to detect and discard duplicate games. The server extracts behavior-related phrases from commentary text, such as “aggressive attack” or “solid defense,” and maps those phrases to style tags. The server outputs cleaned game records stored as sequences of move tuples and a set of style tags associated with each high-skill individual.

### Step 3:

The server encodes game positions and styles into feature tensors.

The server receives, as input, the cleaned game records and style tags from Step 2. For each move in each game, the server reconstructs the board position just before the move and encodes that position into a multi-channel tensor, where each channel represents a piece type, player side, or rule-related flag. The server converts the style tags into numerical style vectors, for example one-hot or low-dimensional continuous vectors. The server combines each board tensor with the corresponding style vector into a structured training sample. The server outputs a training dataset composed of input pairs (board tensor, style vector) with labels indicating the expert's selected move and, optionally, the game outcome.

### Step 4:

The server trains a generative AI model on the structured dataset.

The server receives, as input, the training dataset from Step 3 and hyperparameters such as learning rate and batch size. The server initializes a neural network that includes an input embedding layer for board tensors, an embedding layer for style vectors, several intermediate layers such as transformer or convolutional blocks, a policy head that outputs move probabilities, and a value head that outputs evaluation values. The server repeatedly loads mini-batches of samples, performs forward propagation to compute predicted move distributions and evaluation values, and then computes a loss value using cross-entropy between predicted and actual moves and mean squared error between predicted and target evaluations. The server performs backpropagation to compute gradients and updates network parameters with an optimization algorithm. The server outputs a trained generative AI model with stored parameters in a model file.

### Step 5:

The server prepares a language model for explanations.

The server receives, as input, expert commentary text, interview text, and corresponding game contexts. The server tokenizes each text into subword units and aligns them with simplified descriptions of game positions and moves. The server trains a sequence model that predicts the next token given previous tokens and a context embedding of the game state and selected move. The server applies a loss function such as cross-entropy over token sequences and updates model weights using gradient descent. The server outputs a language model capable of generating explanation text conditioned on move and context information.

### Step 6:

The server initializes a user game session.

The server receives, as input, a session creation request from a terminal, including user identifiers and a selected game type or expert profile. The server allocates a unique session identifier, selects an appropriate generative AI model instance corresponding to the requested game and expert, and initializes an internal game state with a starting board configuration and empty move history. The server stores the session state in volatile memory and optionally in persistent storage. The server outputs the session identifier and initial board state to the terminal.

### Step 7:

The terminal displays the initial game interface.

The terminal receives, as input, the initial board state and session identifier from the server.

The terminal uses its graphics subsystem to draw the board grid, pieces, and any indicators such as side to move. The terminal allocates UI elements for a move input area and a text field for entering a prompt sentence. The terminal associates the session identifier with this interface instance for subsequent communication. The terminal outputs a visible interactive game screen and an active input focus for user operations.

### Step 8:

The user enters a prompt sentence and performs a move.

The user receives, as input, the displayed initial board and UI elements from the terminal.

The user types a prompt sentence into the text field, such as “Play aggressively like an attacking expert and sacrifice material for initiative,” or “Play safely and avoid tactical complications, like a solid defender.” The user selects a piece and a destination square on the terminal's board representation to indicate a move. The user completes the input by confirming the move, for example by releasing a drag or tapping a confirmation button. The user outputs a combination of a prompt sentence and a candidate move to the terminal.

### Step 9:

The terminal sends the user move and prompt sentence to the server.

The terminal receives, as input, the user's move selection and the prompt sentence from Step 8. The terminal encodes the move in a standardized notation, such as a pair of source and destination coordinates, and attaches the current session identifier and the plain-text prompt sentence. The terminal creates a request message and sends it to the server via the communication network using an application protocol. The terminal outputs a network request containing session data, move data, and prompt text.

### Step 10:

The server validates the user move and updates the game state.

The server receives, as input, the request from the terminal, including the session identifier, user move, and prompt sentence. The server retrieves the current game state for the session and passes the move to a rule engine that enumerates legal moves from the current position.

The server compares the user move against the list of legal moves; if the move is illegal, the server constructs an error message and sends it back. If the move is legal, the server updates the internal board state by moving the relevant piece, updates any rule-related flags, and appends the move to a move history list associated with the session. The server outputs an updated game state and a confirmation that the user move has been accepted.

### Step 11:

The server converts the prompt sentence into numerical style information.

The server receives, as input, the accepted prompt sentence and the updated game state from Step 10. The server tokenizes the prompt sentence into tokens and passes them through a text embedding process, such as a pre-trained embedding layer and encoder network, to produce a fixed-length numerical style vector. Alternatively, the server applies a keyword extraction algorithm to detect terms related to aggression, defense, opening strategy, or difficulty level, and sets corresponding dimensions in a style vector. The server normalizes or scales the style vector to a predetermined range. The server outputs a numerical style representation associated with the current session and turn.

### Step 12:

The server encodes the current game state into a model input tensor.

The server receives, as input, the updated game state and the numerical style vector from Step 11. The server constructs a board-state tensor by populating multi-channel matrices with piece positions, side-to-move indicators, and rule-specific information. The server concatenates or otherwise integrates the style vector with the board tensor, for example by concatenation along a feature dimension or by using feature-wise scaling and biasing operations. The server outputs a unified model input data structure that encodes both the game state and the prompt-derived style.

### Step 13:

The server generates an AI move with the generative AI model.

The server receives, as input, the unified model input data from Step 12 and the trained generative AI model parameters from storage. The server loads the model into a computing unit, such as a GPU, and performs forward propagation: the server passes the input through the network's layers, computing intermediate activations, and obtains a raw score vector over candidate moves from the policy head. The server applies a softmax function to convert the raw scores into a probability distribution. The server uses the rule engine to produce a mask of legal moves and multiplies the move probabilities by this mask to eliminate illegal moves.

The server then selects a move based on the filtered distribution, for example choosing the move with the highest probability or sampling according to a temperature-controlled distribution. The server outputs a selected AI move and the associated move probabilities or evaluation values.

### Step 14:

The server generates explanation text for the selected AI move.

The server receives, as input, the selected AI move, the unified model input data, and the language model parameters. The server constructs a context vector or textual summary describing the position, the chosen move, and the style vector. The server feeds the context to the language model's encoder and begins sequence generation with an initial token, such as a start-of-sentence token. The server iteratively computes probabilities for subsequent tokens and selects tokens using a decoding strategy such as greedy decoding or top-k sampling until an end token is produced or a maximum length is reached. The server concatenates the selected tokens to form a natural language explanation sentence. The server outputs an explanation text such as “I bring the queen out early to apply direct pressure on your king side and exploit weaknesses near your king.”

### Step 15:

The server sends the AI move and explanation to the terminal.

The server receives, as input, the selected AI move and the generated explanation text from Step 14. The server constructs a response message that includes the move in standardized notation, the explanation text, and updated game state information such as the new board configuration and turn information. The server transmits this response to the terminal via the communication network. The server outputs a network response that enables the terminal to update the user interface.

### Step 16:

The terminal updates the board display and shows the explanation.

The terminal receives, as input, the server's response, including the AI move, explanation text, and updated board state. The terminal updates its internal representation of the board, moving the piece corresponding to the AI move. The terminal redraws the board on the display device, optionally animating the move for visual clarity. The terminal writes the explanation text into a designated text area so that the user can read the rationale behind the move. The terminal outputs an updated visual game state and visible explanation to the user.

### Step 17:

The server logs battle history data for the turn.

The server receives, as input, information about the user move, AI move, prompt sentence, and game state transitions that occurred during the turn. The server packages these elements into a battle history record that includes session identifier, move index, player role, move notation, board-state hash, style vector, and any evaluation values computed during inference. The server writes this record into a persistent storage structure, such as a database table dedicated to move-level histories. The server outputs a stored log entry that forms part of the complete battle history for the session.

### Step 18:

The server analyzes completed games to evaluate move quality.

The server receives, as input, battle history data for sessions that have reached a final result.

The server iterates over each move in each completed game and reconstructs the corresponding game state before the move. The server calls an external analysis engine with this state to obtain an evaluation value, then applies the move and obtains a new evaluation value. The server computes the difference between the pre-move and post-move values, and stores this delta. The server applies classification rules, such as threshold-based rules on the delta and pattern detection across sequences of moves, to label each move as an excellent move, a poor move, or a clever move. The server outputs labeled move records appended to or associated with the original battle history data.

### Step 19:

The server updates the generative AI model using classified battle history.

The server receives, as input, the labeled move records from Step 18 and the current generative AI model parameters. The server constructs an auxiliary training dataset in which input samples are game states and style vectors, and labels include both the original expert moves and their quality classifications. The server defines an augmented loss function that penalizes predictions that assign high probability to moves labeled as poor and rewards predictions that assign higher probability to moves labeled as excellent or clever. The server runs a fine-tuning process similar to initial training: the server loads batches, computes forward passes, calculates the augmented loss, performs backpropagation, and updates weights. The server outputs an updated generative AI model that more accurately aligns its move probabilities with engine-evaluated quality metrics and user interaction patterns.

### Step 20:

The user continues interaction with adjusted style and improved model behavior.

The user receives, as input, the updated game interface and the AI's responses over multiple sessions. The user may adjust prompt sentences during or between games to request different styles, such as “Now play more solidly and avoid risky queen moves,” or “Use an aggressive attacking approach against my king.” The user observes that the AI's move selection and explanations adapt over time, reflecting both the style indicated by the prompt sentence and improvements from fine-tuning based on prior battle histories. The user outputs new prompt sentences and move inputs, which drive further iterations of the described processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented board game systems primarily focus on static rule enforcement and predetermined difficulty levels. In such systems, processing resources are mainly used to validate user moves and to select counter-moves from a fixed evaluation engine or a small set of heuristics. As a result, the systems do not effectively leverage large-scale historical play information or recent generative AI techniques to model the nuanced behavioral characteristics of highly skilled players. This limitation prevents the system from providing dynamically evolving opponent behavior that reflects real experts' style and prevents the system from delivering rich, position-specific, and user-tailored feedback. Furthermore, traditional architectures generally separate game play logic from analysis logic in a rigid manner. The game play component computes moves, and a separate analysis component may annotate games only crudely, for example by labelling blunders based on a simple evaluation threshold. There is no integrated flow in which in-game state representations, move histories, and evaluation metrics are coherently reused as structured inputs to a generative AI model via prompt sentences. This separation causes redundant data transformations, inefficient use of processing resources, and difficulty in scaling analysis to many simultaneous users, thereby limiting system performance and responsiveness.

In addition, existing systems are typically configured with fixed opponent styles and static difficulty parameters that must be manually tuned by developers. They rarely incorporate iterative learning from accumulated user matches to update opponent models or expert-style profiles. As a consequence, the opponent behavior quickly becomes predictable and does not adapt to changes in user skill levels or to newly observed expert play. This results in suboptimal use of computation and storage resources, because logs and user data are merely archived rather than being processed in a feedback loop that improves the system's internal models.

Moreover, known systems do not integrate user state estimation, such as emotion or engagement state inferred from behavioral or biometric data, into the core control flow of AI move generation and feedback generation. While some systems may adjust difficulty based on win/loss statistics, they do not dynamically modify prompt sentences, sampling strategies, or selection criteria for AI responses based on real-time estimates of user emotional state.

This lack of integration leads to inefficient allocation of computational complexity: for users who are frustrated or fatigued, the system may continue to generate overly complex lines and overly dense explanations that reduce learning effectiveness and engagement.

From a computer-technology standpoint, there is a need for a system architecture and processing method that (i) systematically converts historical expert play and user match logs into structured training data for a generative AI model, (ii) uses prompt sentences to integrate game state, expert behavioral characteristics, and evaluation metrics into a unified inference pipeline, and (iii) updates internal model parameters and control logic in response to ongoing user interactions. Such an architecture should reduce duplication of processing across game play and analysis components, support scalable and low-latency inference, and allow fine-grained adaptation of model behavior and explanation style to a given user and game type. The present invention is directed to improving the functioning of a computer system in these respects.

The specific processing by the specific processing unit 290 of the data processing device 12 in Application Example 1 is realized by the following means.

The present invention provides a server comprising a processor configured to acquire historical play information including past match information and behavioral characteristics of a skilled player, preprocess the historical play information into a training data set including feature information for each skilled player, train a generative AI model by using the training data set as input so as to construct a match-generating generative AI model that imitates the behavioral characteristics of the skilled player, receive from a terminal a match start request and a game type designation and, in response, select the match-generating generative AI model and initialize state management processing that manages a game-state representation corresponding to the game type, receive user move information sequentially transmitted from the terminal, determine validity of the user move information based on the state management processing, and update state information based on valid user move information, generate a prompt sentence by using the updated state information, move history information, and condition information related to the behavioral characteristics of the skilled player as input to the match-generating generative AI model, and cause the match-generating generative AI model to generate a response move as an opponent move based on the prompt sentence, calculate evaluation information related to the response move by inputting the state information and the move history information into an evaluation model or evaluation processing and obtaining an evaluation value related to advantage and disadvantage of each user move, generate, based on the evaluation value and analysis input information including the move history information, a further prompt sentence for generating feedback information including an explanation of match content and improvement suggestions for the user, cause a generative AI model to generate analysis results in natural language based on the further prompt sentence, output the analysis results to the terminal so that the terminal displays the analysis results and corresponding state information in response to a reference operation for each game state by the user, store match data obtained from a plurality of matches with the user, update an internal parameter or a behavioral characteristic representation of the match-generating generative AI model based on the stored match data and new historical play information of the skilled player, and, optionally, estimate an emotional state of the user based on behavioral information or biological information acquired from the terminal and dynamically adjust at least one of contents of the prompt sentence, selection criteria of the response move, and difficulty of the match based on a result of the emotional state estimation. This enables the computer system to integrate game play, evaluation, and feedback generation into a unified, prompt-driven generative AI pipeline that adaptively updates internal models and control parameters, thereby improving processing efficiency, responsiveness, and personalization of opponent behavior and instructional feedback beyond what is achievable with conventional rule-based or static AI game systems.

The term “system” refers to a combination of one or more computing devices, storage devices, communication interfaces, and software components that cooperate to perform the processing described in the claims.

The term “processor” refers to one or more hardware processing units, such as a central processing unit, a graphics processing unit, or a specialized accelerator, configured to execute instructions and perform arithmetic and logical operations.

The term “terminal” refers to an information processing device, such as a handheld device, a head-mounted display device, a personal computer, or any other user-end computing device, that provides a user interface and communicates with the server.

The term “user” refers to an individual who interacts with the terminal to play a game, view analysis, or receive feedback generated by the system.

The term “skilled player” refers to a human player having high proficiency in a particular game domain, whose historical play information and behavioral characteristics are used as a basis for modeling.

The term “historical play information” refers to data representing past games played by a skilled player, including sequences of moves, game results, timestamps, annotations, and any other associated contextual data.

The term “behavioral characteristics” refers to attributes that describe how a skilled player tends to act in a game, including preferred strategies, risk preferences, opening choices, tactical tendencies, and other style-related features.

The term “training data set” refers to a collection of preprocessed and structured data records, derived from historical play information and behavioral characteristics, that serve as input for training a machine-learned model.

The term “feature information” refers to numerical or symbolic representations extracted from raw data, which encode aspects of game states, move histories, and player behaviors in a form suitable for machine learning.

The term “generative AI model” refers to a machine-learned model that is configured to generate output data, such as moves or natural language text, in response to input data, based on patterns learned from a training data set.

The term “match-generating generative AI model” refers to a generative AI model trained and configured to produce game moves and optionally related outputs that imitate the behavioral characteristics of a skilled player in a match.

The term “game type” refers to a category of game supported by the system, such as a particular board game or rule set, which determines the rules, state representation, and legal move space used by the system.

The term “state management processing” refers to computational processing that maintains, updates, and validates a data structure representing the current game state and move history according to the rules of a game type.

The term “game-state representation” refers to a data structure that encodes the current configuration of a game, including positions of pieces or tokens, turn information, and any additional rule-related status information.

The term “match start request” refers to a message or signal transmitted from a terminal to the server, indicating a user's intent to begin a new game session and containing at least user identification and game type designation.

The term “user move information” refers to data that specifies a move input by the user, including information such as source and destination positions, selected piece, promotion flags, and associated timing or metadata.

The term “state information” refers to information representing the current game-state representation and related contextual data maintained by the server during a game session.

The term “move history information” refers to information identifying a chronological sequence of moves executed in a game, including user moves and opponent moves, and related contextual attributes.

The term “condition information” refers to information indicating constraints, preferences, or configuration parameters, including information related to behavioral characteristics of a skilled player, difficulty settings, or explanation styles.

The term “prompt sentence” refers to text or structured input data that conditions behavior of a generative AI model by specifying instructions, context, or constraints used by the model during inference.

The term “response move” refers to a game move generated by the match-generating generative AI model as an opponent move in response to user move information and associated prompt sentences.

The term “evaluation model” refers to an algorithm or machine-learned model configured to compute one or more evaluation values representing the relative favorability of game states or moves.

The term “evaluation processing” refers to computational processing, including but not limited to use of an evaluation model, that determines one or more evaluation values associated with game states or moves.

The term “evaluation value” refers to a numerical or symbolic quantity that indicates at least one of advantage, disadvantage, quality, or impact of a move or position within a game.

The term “analysis input information” refers to information provided as input to a generative AI model or other analysis components, including at least move history information, evaluation values, and optionally state information and condition information.

The term “feedback information” refers to output information generated for a user, including explanations of game content, identification of mistakes and strong moves, improvement suggestions, and related advisory content.

The term “analysis results” refers to natural language output or other structured explanatory output generated by a generative AI model based on analysis input information and a prompt sentence.

The term “match data” refers to data collected from one or more completed or ongoing games between a user and an AI-controlled opponent, including move sequences, state trajectories, results, and associated metadata.

The term “internal parameter” refers to a value stored within a machine-learned model, such as a weight or bias, that is adjusted during training or updating to modify the behavior of the model.

The term “behavioral characteristic representation” refers to an internal data structure, such as an embedding vector or profile, representing behavioral characteristics of a skilled player within the match-generating generative AI model.

The term “behavioral information” refers to data relating to a user's interaction pattern with a terminal, including but not limited to input timing, move duration, error frequency, and interface navigation patterns.

The term “biological information” refers to data obtained from sensors related to a user's physiological state, such as heart rate, skin conductance, facial expression data, or other biosignals.

The term “emotional state” refers to an inferred psychological condition of a user, such as stress, frustration, engagement, or confidence, estimated based on behavioral information, biological information, or both.

The term “emotion estimation processing” refers to computational processing that estimates a user's emotional state from behavioral information, biological information, or a combination thereof.

The term “selection criteria of the response move” refers to rules or parameters that influence how a generated response move is selected among candidate moves, including criteria based on evaluation values, randomness, or difficulty settings.

The term “difficulty of the match” refers to a parameter or set of parameters controlling the challenge level presented to a user, including but not limited to strength of moves, frequency of hints, and complexity of strategies used by the AI.

The term “strategy policy” refers to a high-level description or configuration of how an AI opponent is to conduct a game, including preferred plans, risk levels, and phase-specific objectives.

The term “explanation style” refers to characteristics of explanatory text generated for a user, including level of detail, technicality, tone, length, and structure of explanations.

The term “natural language” refers to a human language, such as English, in which textual explanations, feedback, and analysis results are expressed.

In one embodiment, a server provides core processing for a game support system that models a skilled player and generates adaptive feedback. The server includes at least one central processing unit and, in some implementations, one or more graphics processing units.

The server executes software components implemented, for example, in a high-level language and running on an operating system. The server communicates with one or more terminals over a network by using a communication interface and a protocol such as HTTPS or WebSocket.

The server stores historical play information in a storage device, such as a relational database or a structured file store. The server stores, for each skilled player and each game type, a sequence of positions, moves, results, timestamps, and annotations. The server also stores behavioral characteristics, such as risk preference scores, opening repertoire indicators, and style descriptors, as numeric vectors or categorical attributes linked to each skilled player. The server preprocesses the historical play information by executing a data processing module. The server parses raw game records by using a rules engine library specific to each game type, such as a chess rules library or a shogi rules library. The server converts each game into a normalized sequence of game-state representations. Each game-state representation is stored, for example, as a multi-dimensional array that encodes piece types, positions, side to move, castling rights or equivalent rule flags, and additional game-phase indicators. The server aligns each game-state representation with the corresponding move taken by the skilled player, producing labeled pairs of (state, move).

The server generates feature information from the labeled pairs. The server converts each game-state representation into a tensor by applying a feature extractor. The feature extractor encodes board occupancy, piece types, legal move masks, and historical information, such as the last N moves, into numeric channels. The server encodes behavioral characteristics of the skilled player as an embedding vector, which is concatenated or otherwise combined with the board tensor. The server also encodes contextual information, such as game phase (opening, mid-game, endgame) and game type, as additional feature dimensions. The result is a training data set composed of input tensors and target move labels.

The server trains a generative AI model by using the training data set. In one embodiment, the generative AI model is a transformer-based neural network. The server defines an architecture composed of an input embedding layer, multiple attention layers, and one or more output heads. One output head produces a probability distribution over possible moves, and another optional output head produces tokens for natural language commentary. The server configures an optimization algorithm, such as Adam, with parameters including learning rate, weight decay, and batch size.

The server loads training batches of feature tensors and target moves into memory and performs forward propagation through the generative AI model. The server computes a loss function that includes at least a cross-entropy term between the predicted move distribution and the target move label. The server optionally includes a regularization term that constrains the output distribution to remain close to an evaluation engine's best-move distribution, thereby improving move quality. The server performs backpropagation to calculate gradients of the loss with respect to model weights, then updates the weights according to the optimization algorithm.

The server repeats the training process over many epochs, monitoring performance on a validation subset. The server adjusts hyperparameters or learning rate schedules based on convergence behavior. The server stores intermediate checkpoints in model storage. The server selects one or more checkpoints as match-generating generative AI models for deployment. Because the server uses a transformer-based architecture and game-specific feature encodings, the server improves prediction accuracy and reduces training instability compared to generic sequence models.

The server configures the generative AI model to accept not only feature tensors derived from game states but also prompt sentences that specify high-level behavior. The server encodes prompt sentences as token sequences input to a textual encoder portion of the model or to a separate language model. The server combines the encoding of the prompt sentence with the encoding of the game state and behavioral characteristic vectors, for example by concatenation or cross-attention. This design allows the server to adjust model behavior at inference time without retraining, thereby improving computational efficiency and enabling dynamic control.

In one example, the server uses the following prompt sentence during a match:
“Play as a skilled attacking player in this board game. Prioritize active piece development and tactical opportunities, but avoid obvious material blunders. Provide moves that challenge an intermediate user while remaining instructive.”

The server tokenizes this prompt sentence, encodes it into an internal representation, and conditions the move-generation head on this representation. Because the server merges symbolic instructions with tensor-based game-state features, the server can modify opponent style or difficulty by modifying the prompt sentence, while reusing the same trained weights.

The terminal provides a user interface for game play and analysis. The terminal may be a smartphone, a tablet, a personal computer, or a head-mounted display. The terminal executes a client application that renders a game board view based on game-state information received from the server. The terminal captures user move input via touch, mouse, controller, or gesture interfaces and locally validates basic legality by using a lightweight rules module.

The terminal formats valid moves as structured messages and sends them to the server through a network interface.

The server receives each user move and updates an internal game-state representation. The server uses a rules engine to apply the move, verify legality at full rule depth, and compute any derived state information, such as check, checkmate, captured pieces, or scoring. The server maintains, in working memory, a move history buffer that stores recent moves and corresponding evaluation values. The server updates this buffer for each new move.

The server generates a prompt sentence for move generation by incorporating current state information, move history, and behavioral conditions. For example, the server may build a prompt sentence such as:
“Current move number: 15. The user has just played an aggressive kingside attack. Respond in the style of a cautious positional player, seeking to neutralize the attack and gradually improve piece placement.”

The server concatenates this prompt sentence with an encoded representation of the board position and behavioral characteristic embedding. The server executes an inference call to the generative AI model on the GPU or CPU. The server obtains a probability distribution over candidate moves. The server then applies a constrained decoding algorithm that enforces legal-move masks provided by the rules engine and optionally adjusts sampling temperature or top-k parameters based on desired difficulty. The server selects a response move that satisfies both legal constraints and style preferences.

The server evaluates the response move and the corresponding position by using an evaluation model or evaluation processing. In one embodiment, the server uses a separate evaluation engine, such as a search-based board game engine, to compute a numerical evaluation value. The server passes the current game-state representation and the selected move to the evaluation engine, receives an evaluation score, and compares it with prior scores. The server stores the resulting evaluation values in the move history buffer. This architecture enables the server to compute accurate and consistent evaluation values while offloading tactical depth to a specialized algorithm.

After a match concludes, the server performs analysis using accumulated state and evaluation information. The server reconstructs each position from the recorded moves and evaluation values. The server identifies critical positions where the evaluation value changed significantly due to a user move. The server prepares analysis input information that includes the move sequence, evaluation values, and context tags such as “opening phase mistake” or “endgame tactic.”

The server generates a prompt sentence for feedback generation. For example, the server may use:
“Using the following game record and evaluation metrics, generate feedback for an intermediate-level user. Highlight excellent moves, bad mistakes, and clever tactics. Explain what the user could have done differently in the opening, mid-game, and endgame. Use clear, step-by-step explanations.”

The server sends this prompt sentence, together with the analysis input information, to a generative AI model configured for natural language output. The server may reuse the same transformer backbone as the match-generating model or may use a related model fine-tuned for explanation tasks. The server encodes the game record and evaluation values into a sequence format and concatenates it with tokens of the prompt sentence. The server runs inference to obtain analysis results as natural-language text.

The terminal receives the analysis results and associated position identifiers. The terminal displays the analysis in a structured screen that allows the user to select a move index and view the corresponding board position with highlighted recommended alternatives. The terminal may allow the user to request further detail on specific moves, in which case the terminal sends an additional request to the server. The server can respond by generating a more focused prompt sentence such as:
“Explain in more detail why the user's move on turn 23 was a mistake, and show at least two better alternatives with short variations.”

This interactive process allows the server to provide multi-level explanations without retransmitting entire game logs, thereby reducing communication overhead.

In another embodiment, the server estimates a user's emotional state based on behavioral or biological information sent from the terminal. The terminal may measure interaction metrics, such as pause duration before each move, error corrections, or rapid resignations, and may also provide biometric signals from available sensors. The server executes an emotion estimation module, which may be a separate neural network that maps behavioral and biological feature vectors to one of several emotional states. The server then modifies configuration of the generative AI model in response to the estimated emotional state.

For instance, if the server detects that the user exhibits signs of frustration, the server may lower move complexity by reducing search depth in the evaluation engine and by adjusting sampling parameters to prefer safer moves. The server may also generate a prompt sentence that instructs the generative AI model to produce more encouraging and simplified feedback, such as:
“The user appears frustrated. Provide short, supportive comments and focus on one or two key improvement points rather than detailed analysis.”

By integrating emotion estimation with prompt-based control, the server changes internal decision thresholds and resource allocation strategies, thereby improving user engagement and making more efficient use of computational resources. This behavior is not a mere automation of a human coach's decision, because the server simultaneously adjusts low-level inference parameters, such as sampling temperature and feature weighting, in ways that would be impractical to reproduce manually in real time.

The server periodically updates internal parameters and behavioral characteristic representations of the match-generating generative AI model by using stored match data. The server aggregates many user games and real-world games of the skilled player. The server constructs new training data sets that reflect both the skilled player's ongoing performance and typical user interactions. The server then performs incremental training or fine-tuning. The server may use strategies such as learning-rate warm restarts, selective freezing of earlier layers, and replay buffers that mix old and new data to prevent catastrophic forgetting. This continuous update process allows the system to adapt the model to changing environments and user populations, improving move quality and feedback relevance.

Because the server reuses a unified architecture and internal data structures for both game play and analysis, the server reduces redundant encoding and decoding processes. The server stores game states, evaluation values, and behavioral vectors in a consistent format that is directly consumable by both move-generation and explanation-generation components. This unified design improves processing throughput and reduces latency, especially under high concurrent user load. The server can scale horizontally by distributing different user sessions across multiple machines while keeping the model and feature formats consistent.

The terminal also participates in efficiency improvements. The terminal performs local move validation for basic rule checks, reducing the number of invalid move messages sent to the server. The terminal can cache recent analysis results to avoid redundant requests when the user repeatedly views the same position. In some implementations, the terminal may prefetch likely next positions based on server hints, reducing perceived latency when the user navigates through the game.

The user interacts with the system by selecting game types, starting matches, making moves, and requesting analysis. The user does not need to understand internal model logic, because the server and terminal coordination hides complexity. However, the user benefits from technical improvements such as faster response time for AI moves, more accurate modeling of expert style, and more targeted feedback that reflects both move quality and estimated emotional state.

The described system improves computer technology in several concrete ways. The server uses specialized tensor encodings for game states, rather than generic text encodings, which increases inference efficiency and move prediction accuracy. The server combines symbolic prompt sentences with numeric feature representations inside a single architecture, which enables dynamic style and difficulty control without retraining. The server employs non-conventional integration of evaluation engines and generative models by feeding evaluation values and critical-position markers back into the generative model for explanation tasks. This reduces the need for separate ad hoc analysis code and improves coherence between move selection and feedback content.

Furthermore, the server's emotion-aware control mechanism modifies inference parameters based on estimated user state, which changes how compute resources are allocated over time. For example, the server can reduce depth for unimportant positions while increasing depth and explanation detail for positions that strongly affect game outcome or learning. This leads to reduced overall compute consumption while maintaining or improving perceived quality of AI behavior. The causative link between these design choices and technical effects lies in the explicit use of structured feature encodings, unified internal representations, and prompt-controlled inference paths that allow fine-grained and context-aware adjustment of processing at the hardware level.

Alternative embodiments are also possible. The server may use a different neural network architecture, such as a convolutional-residual network, for board encoding, coupled to a transformer for prompt processing. The server may implement evaluation processing entirely within the neural network by training an additional value head instead of using an external engine. The server may deploy smaller distilled models to edge servers for reduced latency under constrained network conditions. In each case, the core concepts of structured feature extraction, prompt-controlled generative behavior, evaluation-guided analysis, and continuous model updating remain applicable.

By implementing these embodiments, the server, the terminal, and the user cooperate in a system that goes beyond generic data retrieval or business workflow automation. The system modifies internal machine-learned structures, manages specialized data representations, and orchestrates neural inference and symbolic evaluation engines in a coordinated manner. As a result, the system achieves technical effects such as improved computation efficiency, reduced network load, faster and more accurate move generation, and more effective feedback delivery, which collectively constitute an improvement in the functioning of the computer system itself.

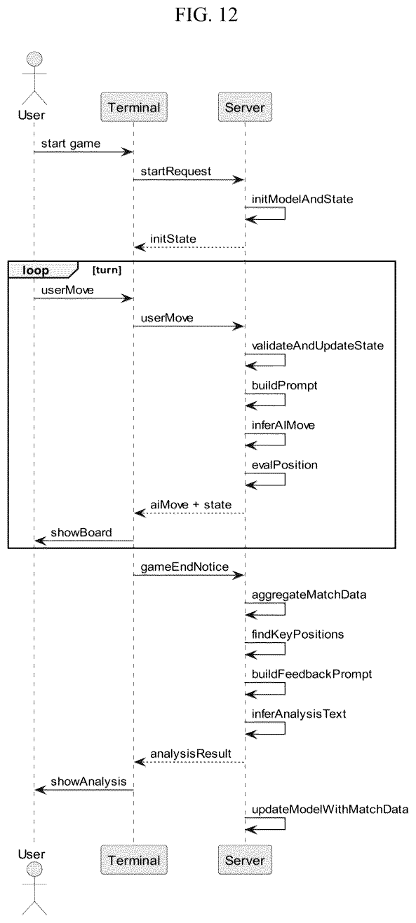

The following describes the processing flow using FIG. 12.

### Step 1:

Server acquires and preprocesses historical play information.

Server receives, as input, raw game records of skilled players and metadata, including move lists, timestamps, results, and style annotations, from storage or external sources. Server parses each record by using a game rules engine, converts moves into standardized notation, and reconstructs a sequence of game-state representations. Server performs data operations that include validating move legality, normalizing coordinates, extracting features such as piece positions and game phase, and associating each position with the corresponding skilled player identifier and behavioral characteristics. Server outputs a cleaned and structured data set in which each entry contains a game-state representation, a target move, and a behavioral characteristic vector.

### Step 2:

Server converts structured data into feature tensors for model training.

Server receives, as input, the structured data set from Step 1. Server encodes each game-state representation into a multi-dimensional tensor that includes channels for piece type, ownership, legal moves, and historical context. Server encodes behavioral characteristics and game-type indicators as numeric feature vectors or embeddings, and then concatenates or combines them with the board tensor. Server performs data operations such as normalization, padding or truncation of move histories, and batching of multiple examples into fixed-size mini-batches. Server outputs training batches that each contain a tensor of input features and a corresponding tensor or vector of target move labels.

### Step 3:

Server trains a generative AI model using the feature tensors.

Server receives, as input, the training batches from Step 2 and an initial set of model parameters for a neural network architecture, such as a transformer-based generative AI model. Server performs forward propagation to compute predicted move distributions for each input batch, then computes a loss value by applying a cross-entropy function between predicted distributions and target move labels, optionally adding regularization terms based on evaluation engine outputs. Server executes backpropagation to compute gradients and applies an optimization algorithm to update the model parameters. Server repeats this process over many batches and epochs, and evaluates intermediate models on validation data. Server outputs a trained match-generating generative AI model and stores its parameters and configuration in model storage.

### Step 4:

Server initializes a game session and loads the trained model.

Server receives, as input, a match start request from a terminal, including user identification, selected game type, and selected skilled player type. Server retrieves the corresponding trained match-generating generative AI model from storage and loads its parameters into memory. Server initializes a game-state representation to the starting position for the selected game type by using the rules engine, and creates an empty move history buffer. Server constructs an initial prompt sentence that encodes high-level behavior, such as “Play as a skilled positional player and provide instructive but challenging moves.” Server stores this prompt sentence or its encoded form as part of the session context. Server outputs a session identifier, initial game-state information, and skilled player profile, which are sent to the terminal.

### Step 5:

Terminal displays the initial game state and collects user input.

Terminal receives, as input, the initial game-state information and session identifier from the server. Terminal renders the game board and piece positions on a display and presents controls for user interaction. Terminal waits for the user to select or enter a move by using touch, mouse, controller, or gesture input. Terminal performs basic rule checks locally, such as verifying that a piece moves within allowed directions and that the destination square lies inside the board. If the move is locally invalid, terminal rejects the move and displays an error message. If the move is valid at this level, terminal formats user move information, including source and destination squares, promotion flags, and local timestamps. Terminal outputs a structured move message and transmits it to the server.

### Step 6:

Server validates the user move and updates the game state.

Server receives, as input, the user move information and the session identifier from the terminal. Server retrieves the current game-state representation for the session and applies the move by using the rules engine. Server performs full legality checks, including checks for self-check, repeated positions, or other game-specific constraints. If the move is illegal, server generates an error response indicating the reason and sends it back to the terminal. If the move is legal, server updates the internal game-state representation, appends the move to the move history buffer, and recalculates derived attributes such as check status or material balance. Server outputs the updated game-state representation and updated move history.

### Step 7:

Server generates a prompt sentence for AI move generation.

Server receives, as input, the updated game-state representation, the move history buffer, and the stored behavioral characteristic vector for the selected skilled player. Server analyzes the current state, for example by determining game phase and identifying whether the user's last move was aggressive or defensive based on heuristic rules or evaluation values. Server composes a prompt sentence that reflects this context, such as “Current move number: 15. The user has launched an aggressive attack. Respond in a solid defensive style, preserving material and preparing counterplay.” Server performs string concatenation and template filling to build the prompt sentence and encodes it into tokens if required by the generative AI model. Server outputs the encoded prompt sentence and the corresponding feature tensors derived from the current state and behavior vectors.

### Step 8:

Server generates an AI response move using the generative AI model.

Server receives, as input, the encoded prompt sentence and the feature tensors from Step 7, along with the loaded parameters of the match-generating generative AI model. Server feeds the combined textual and numeric inputs into the model, executes forward propagation, and obtains a probability distribution over all candidate moves. Server applies a legal-move mask provided by the rules engine to set probabilities of illegal moves to zero. Server may adjust the distribution with a sampling temperature or top-k filtering based on desired difficulty.

Server then samples or selects a move index according to the adjusted distribution. Server converts the selected index back into a concrete move (source square, destination square, promotion, etc.) using a move-encoding map. Server outputs the response move and an updated internal state of the generative AI model if required.

### Step 9:

Server updates evaluation values for the new position.

Server receives, as input, the response move from Step 8 and the current game-state representation. Server applies the response move to the game-state representation by using the rules engine and produces a new state. Server calls an evaluation processing component or evaluation model, passing as input the new state and optionally the previous state. The evaluation component computes a numerical evaluation value indicating advantage or disadvantage for the user, for example by running a search-based engine or a value network.

Server compares the new evaluation value with the previous evaluation value to quantify the impact of the user's last move and the AI's response. Server writes the evaluation value and impact measure into the move history buffer. Server outputs the updated game-state representation and the updated move history with evaluation values.

### Step 10:

Server sends the AI move and updated state to the terminal.

Server receives, as input, the response move and the updated game-state representation from Step 9. Server packages these into a response message that includes move notation, captured pieces, check status, clocks or timers if applicable, and any summary indicators such as evaluation score bars. Server transmits this response message to the terminal. Server also stores the user move, AI move, and evaluation values in persistent storage as part of match data. Server outputs a confirmation that the message was successfully sent, and returns to a waiting state for the next user move.

### Step 11:

Terminal renders the AI move and continues interaction.

Terminal receives, as input, the response message from the server. Terminal updates the board display by moving the relevant piece to the destination square and indicating any captures or special moves. Terminal updates auxiliary indicators such as whose turn it is, remaining time, and evaluation bar. Terminal may display a short comment if provided, or a generic notification that the AI has moved. Terminal waits for the next user input and repeats the move input process. Terminal outputs updated visual and interactive states to the user, enabling continuous play until a game-ending condition occurs.

### Step 12:

Server detects game termination and aggregates match data.

Server receives, as input, game-state updates that indicate potential terminal conditions, such as checkmate, resignation, stalemate, or score threshold. Server checks termination rules by using the rules engine. When a terminal state is confirmed, server marks the session as completed and aggregates all stored move entries and evaluation values for that session.

Server compiles a complete match record that includes the sequence of states, moves, evaluation values, and timestamps. Server outputs an aggregated match record and associated metadata for use in post-game analysis.

### Step 13:

Server prepares analysis input and identifies key positions.

Server receives, as input, the aggregated match record from Step 12. Server iterates through the move sequence and evaluation values, computing derived features such as evaluation difference caused by each user move and phase classification for each move. Server identifies key positions where the evaluation difference exceeds a threshold, designating them as critical mistakes or strong tactical plays. Server constructs analysis input information that includes the full move history, evaluation curves, and tags for critical positions. Server outputs this analysis input information in a structured format that can be consumed by a generative AI model responsible for explanation.

### Step 14:

Server generates a prompt sentence for feedback and explanatory analysis.

Server receives, as input, the analysis input information and user profile information, such as estimated skill level. Server constructs a prompt sentence that instructs the generative AI model to produce detailed feedback. For example, server may generate: “Using the following game record and evaluation metrics, generate feedback for an intermediate-level user.

Highlight excellent moves, bad mistakes, and clever tactics. Explain what the user could have done differently in the opening, mid-game, and endgame. Use clear, step-by-step explanations.” Server embeds references to the analysis input information, such as lists of critical moves, into the prompt by textual description or by structured tags. Server outputs the final prompt sentence and a serialized representation of the game record and evaluation metrics.

### Step 15:

Server generates analysis results using a generative AI model.

Server receives, as input, the prompt sentence and the serialized analysis input information from Step 14. Server encodes the prompt sentence into tokens and transforms the serialized game and evaluation data into an input sequence or tensor that the generative AI model can parse. Server feeds these combined inputs into the generative AI model configured for natural language generation. Server runs forward propagation and decodes the output token sequence into text representing analysis results. Server may apply post-processing, such as segmenting the text into sections “Summary,” “Key Mistakes,” and “Best Moves,” based on token patterns or markers. Server outputs the finalized analysis results as natural-language text associated with position indices.

### Step 16:

Server delivers analysis results to the terminal.

Server receives, as input, the analysis results and their associated position indices from Step 15. Server constructs a response message containing the textual feedback and a mapping from text segments to specific moves or positions. Server transmits this message to the terminal over the network. Server records that analysis has been generated for this match and may store a compact version of the results for future reference. Server outputs a delivery confirmation and frees some working memory associated with the session.

### Step 17:

Terminal presents analysis results and supports interactive review.

Terminal receives, as input, the analysis results and the mapping to positions from the server. Terminal displays the analysis results in a dedicated analysis screen, grouping explanations into sections such as summary and key positions. Terminal allows the user to select a described move, for example by tapping an entry or selecting a list item. When the user selects a move, terminal retrieves or reconstructs the corresponding board state using local or server-provided data and updates the board display to that state. Terminal outputs the updated visual representation and the associated portion of the analysis text, enabling the user to explore the game in conjunction with the explanations.

### Step 18:

Server updates model parameters based on accumulated match data.

Server receives, as input, stored match data from multiple completed sessions, including user move sequences, AI responses, evaluation values, and analysis usage statistics. Server aggregates this data and constructs a new training or fine-tuning data set that reflects typical user mistakes, successful strategies, and expert updates. Server performs additional training on the match-generating generative AI model or a related model, using similar weight update procedures as in Step 3. Server may adjust loss functions to emphasize correction of frequent user errors or to align generated commentary with observed user comprehension patterns.

Server outputs updated model parameters and behavioral characteristic representations, and deploys these updates for future sessions, thereby closing the loop between live usage and model improvement.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented board game systems and computer game engines mainly focus on optimizing move strength or entertainment value from the perspective of a generic artificial opponent. Such systems typically rely on fixed evaluation functions or pre-trained models that do not faithfully reproduce the play style and personality characteristics of real-world expert players, and that do not provide structured, high-resolution feedback to those expert players themselves. As a result, several technical issues arise in the way information processing resources are utilized and in the way training data is generated and consumed in such systems.

First, in known systems, data pipelines for acquiring past match records of expert players and transforming the acquired records into machine-readable training data are often ad hoc and isolated from the runtime inference environment. This separation leads to inefficient use of storage and computation resources, because the same information may be redundantly stored or repeatedly preprocessed, and because the trained models are not systematically deployed and updated within an integrated architecture. Consequently, processor cycles and memory bandwidth are not effectively allocated across data acquisition, model training, and online inference.

Second, conventional AI opponents in board game platforms do not tightly couple generative artificial intelligence models with session-specific game state management in real time. In many cases, the engine calculates moves independently of user-facing session identifiers or server-side session stores. Such loose coupling can cause inconsistent game state reconstruction, redundant rule-checking computations, and increased latency when mapping from user input to an internal board representation, and then to an AI move and back to a rendered board. This degrades the responsiveness and scalability of the system, especially under high concurrency, and makes it difficult to provide a consistent, expert-style playing experience.

Third, existing systems do not effectively exploit post-game analysis to refine the underlying generative models and to improve the overall computing pipeline. While separate analysis engines may be used to annotate games, these analyses are rarely reintegrated into the training data or used to systematically adjust model parameters. As a result, the generative model remains static, and its representation of an expert's style fails to evolve based on newly generated interaction data. There is no unified mechanism to close the loop between inference (real-time play), evaluation (post-game analysis), and training (model updates), leading to suboptimal utilization of computational resources and storage structures.

Fourth, known architectures typically lack an integrated control mechanism that dynamically adjusts inference conditions and strategy patterns of a generative model according to user-specified game type, difficulty level, and desired opponent personality characteristics.

Without such dynamic control, the server must either maintain multiple separately trained models or perform repeated manual configuration, which increases memory footprint and configuration overhead, and limits the system's ability to adaptively manage resource allocation per session.

Therefore, there is a need for a computer-implemented system that: (i) structurally acquires and stores expert match and personality data for use in training a generative artificial intelligence model, (ii) integrates that model with a session-aware inference pipeline for real-time interactive play, (iii) performs automatic post-game analysis to classify moves and generate feedback, and (iv) uses the results of such analysis, together with user-selected conditions, to update the model and to dynamically control its inference behavior. By addressing these issues in an integrated manner, the present invention aims to improve the efficiency, scalability, and adaptability of the underlying computer technology used for expert-style, AI-mediated board game interactions.

The specific processing by the specific processing unit 290 of the data processing device 12 in Example 2 is realized by the following means.

The present invention provides a server comprising a processor and a memory storing instructions that, when executed by the processor, cause the processor to acquire, from an external information providing apparatus, information concerning past match records and personality characteristics of a real-world expert player, and store the acquired information as structured information in an information storage apparatus; preprocess the information concerning the past match records and the personality characteristics stored in the information storage apparatus, train a generative artificial intelligence model on a matrix computation apparatus using the preprocessed information, generate, as an inference model, a model that imitates a play style of the expert player, and deploy the inference model to an inference execution environment; generate, based on a match start request and information indicating a type of a competitive game received from a terminal apparatus, a match session, and transmit session identification information and initial position information to the terminal apparatus; update a current game position based on instruction information indicating a user turn and the session identification information received from the terminal apparatus, convert the current game position into an input format of the inference model, calculate a probability distribution of candidate next moves by using the inference model, determine a next move as an opponent move based on the probability distribution, and transmit the determined next move and updated position information to the terminal apparatus; store, in the information storage apparatus, sequence information of all moves, match result information, and time information generated in accordance with progress of the match session, input stored match data into an analysis evaluation program, classify each move into at least one of an excellent move, an inferior move, and an ingenious move based on an evaluation value, and generate evaluation information including a classification result; aggregate the evaluation information into a format presentable to the expert player, and output, as feedback information, the evaluation information including statistical information indicating characteristics of the play style of the expert player and improvement candidate information; and update training information for the generative artificial intelligence model and readjust parameters of the generative artificial intelligence model based on a match result produced by the inference model and a classification result of each move generated by the analysis evaluation program, and further switch inference conditions and behavior policies of the generative artificial intelligence model based on game type information, difficulty information, and desired condition information regarding opponent personality characteristics, which are input by a user via the terminal apparatus. This enables an integrated computer architecture in which data acquisition, model training, online inference, post-game analysis, and adaptive model control are performed in a coordinated manner, thereby improving utilization of processing and storage resources, reducing latency in interactive expert-style gameplay, and enhancing the ability of the system to evolve and personalize generative AI behavior over time.

The term “external information providing apparatus” refers to an information processing apparatus or service, such as a remote data server or application programming interface, that supplies match record data and personality-related data of human players to the server over a communication network.

The term “past match records” refers to structured or semi-structured data representing historical game information, including at least sequences of moves, identifiers of participants, timestamps, game results, and any associated contextual metadata.

The term “personality characteristics” refers to play-style-related attributes of a player, including but not limited to preferred openings or strategies, typical levels of risk-taking, time management habits, and characteristic tactical or positional tendencies.

The term “structured information” refers to data that has been organized into a predefined schema or data model, such as tables, records, or objects, enabling efficient querying, indexing, and processing by the server.

The term “information storage apparatus” refers to a storage device or storage subsystem, such as a database system or file system, configured to persistently store structured information and other data used by the server.

The term “preprocess” refers to operations performed on raw or semi-structured data, including at least parsing, cleaning, normalizing, encoding, and transforming the data into a representation suitable for training or inference by a machine learning model.

The term “generative artificial intelligence model” refers to a machine learning model configured to generate outputs, such as next-move predictions, that statistically reflect patterns learned from training data, including patterns associated with an expert player's style.

The term “matrix computation apparatus” refers to a processing unit or set of processing units, such as a central processing unit or graphics processing unit, optimized or configured to perform numerical linear algebra operations, including matrix multiplications and tensor operations used in model training and inference.

The term “inference model” refers to an instance of a trained generative artificial intelligence model configured for deployment and execution to produce predictions or decisions, such as next-move selections, based on input data.

The term “inference execution environment” refers to a runtime environment, such as a serving framework or application server, in which the inference model is loaded and executed in response to inference requests.

The term “terminal apparatus” refers to a user-operated computing device, such as a client terminal, mobile device, or personal computer, configured to send input data and receive output data from the server over a communication network.

The term “match session” refers to a logically identified interaction instance between a user and an artificial opponent, including a specific game instance, its associated state, and related metadata maintained during the interaction.

The term “session identification information” refers to data, such as a unique identifier, that distinguishes one match session from another and enables the server to associate incoming requests with a particular session state.

The term “initial position information” refers to data defining a starting configuration of a game environment, including the initial placement of game pieces and any initial parameters specific to a game type.

The term “instruction information indicating a user turn” refers to data representing a user's action within a game, including a selected move or command, associated with a specific match session and game state.

The term “current game position” refers to a representation of the state of the game at a particular time, including at least the positions of game elements and turn information.

The term “input format of the inference model” refers to a particular data representation, such as an encoded tensor or feature vector, required by the inference model for processing an input game state.

The term “probability distribution of candidate next moves” refers to a mapping from potential game moves to probability values, generated by the inference model, indicating estimated likelihoods or preferences for those moves.

The term “opponent move” refers to a move selected by the inference model and presented as the move of an artificial opponent in the context of the match session.

The term “updated position information” refers to data describing the game state after application of a move, including any resulting changes in piece placement, turn status, and other game parameters.

The term “sequence information of all moves” refers to ordered data capturing each move made during a match session, including move order, move representation, and optionally associated timestamps or annotations.

The term “match result information” refers to data indicating the outcome of a match session, such as win, loss, draw, or other end conditions.

The term “time information” refers to data related to temporal aspects of a match session, including at least per-move time consumption, total session time, and timing at which moves were made.

The term “analysis evaluation program” refers to software configured to evaluate game positions and moves, for example using search algorithms or evaluation functions, and to produce quantitative or qualitative assessments of move quality.

The term “evaluation value” refers to a numeric or symbolic measure produced by the analysis evaluation program that indicates the relative quality or strength of a given move or game position.

The term “excellent move” refers to a move classified, based on evaluation values, as maintaining or improving the player's position to a high degree relative to alternative moves.

The term “inferior move” refers to a move classified, based on evaluation values, as significantly worsening the player's position relative to alternative moves.

The term “ingenious move” refers to a move classified, based on evaluation values and contextual analysis, as an unexpected but effective move, such as a creative tactical or strategic choice.

The term “evaluation information” refers to data generated by the analysis evaluation program that includes classification results, evaluation values, and any associated annotations for moves or positions.

The term “statistical information indicating characteristics of the play style” refers to aggregated metrics derived from evaluation information and match records that describe patterns in a player's decision-making, such as frequencies of certain move types or error rates in specific situations.

The term “improvement candidate information” refers to guidance or indicators derived from evaluation information and statistical information, suggesting areas where a player's decision-making can be enhanced.

The term “feedback information” refers to information that combines evaluation information, statistical information, and improvement candidate information, formatted to be interpretable by a human player for study or self-improvement.

The term “training information for the generative artificial intelligence model” refers to data and associated labels used to train or fine-tune the generative artificial intelligence model, including input representations of game states and target outputs such as expert moves or classifications.

The term “parameters of the generative artificial intelligence model” refers to numeric values, such as weights and biases of a neural network, that determine the behavior of the generative artificial intelligence model during inference.

The term “inference conditions” refers to configurable settings used during execution of the inference model, including temperature values, exploration parameters, search depth limits, or other parameters affecting the selection of moves.

The term “behavior policies” refers to high-level strategies or decision rules used by the inference model when choosing moves, which may emphasize factors such as aggressiveness, safety, or stylistic biases.

The term “game type information” refers to data indicating the category or rule set of a game to be played, such as a particular board game type or variant.

The term “difficulty information” refers to data indicating a desired challenge level for the artificial opponent, which may affect inference conditions, search depth, or other aspects of the inference process.

The term “desired condition information regarding opponent personality characteristics” refers to user-specified preferences defining the desired style or behavioral characteristics of the artificial opponent, such as aggressiveness, defensiveness, or preference for specific strategies.

In one embodiment, a server, a terminal, and a user cooperate to realize the invention. The server includes at least one processor, a memory, a non-transitory storage apparatus such as a relational database system, and one or more matrix computation devices such as graphics processing units. The terminal includes a processor, a memory, a display, an input interface, and a communication interface. The user operates the terminal to initiate matches, input moves, and review analysis results.

The server executes software modules implemented, for example, using a server-side runtime such as a general-purpose operating system, a web framework, a database management system, and a machine learning framework. The server uses a database system such as a relational database engine to store structured information, and uses a machine learning framework such as a tensor-based numerical computation library (for example, TensorFlow or PyTorch) to implement and train a generative AI model. The server further uses a game analysis engine, for example a chess or board game engine, executed as a separate process, to evaluate positions and moves for post-game analysis.

The server acquires past match records and personality characteristics of expert players from an external information providing apparatus. The external apparatus can be implemented as a remote game archive server or an application programming interface accessible via a communication network. The server uses a communication stack, for example an HTTP client library, to retrieve data in structured or semi-structured formats such as Portable Game Notation or JSON. The server parses the retrieved data and converts it into internal data structures such as records and tables. For example, the server stores each game as a game record including game identifier, participant identifiers, date, result, and game type, and stores each move as a move record including move index, move notation, time spent, and an optional score.

The server converts these records into structured information suitable for machine processing. The server normalizes player names into expert identifiers, maps move notations into numeric indices representing board coordinates, and encodes personality characteristics into feature vectors. A personality feature vector may include, as components, an aggression level value, an opening repertoire identifier, a typical time-usage profile, and positional versus tactical preference indicators. The server writes the structured information into the information storage apparatus using insert and update operations. By imposing a schema including primary keys for expert identifiers and game identifiers, the server enables efficient indexed retrieval and avoids redundant storage.

The server preprocesses the data for training the generative AI model. The server performs parsing, cleaning, and filtering operations. For example, the server removes duplicate games, discards games shorter than a threshold number of moves, and filters by rule set or time control category. The server then generates input-output pairs for the model. For each game position, the server constructs an input tensor encoding piece placements, castling rights, turn, move number, and additional context such as time remaining. The server also concatenates a personality vector of the expert associated with the game to this input. The target output is a move index representing the expert's actual move in that position. The server stores the resulting tensors in a format suitable for batch loading.

The server initializes a generative AI model using the machine learning framework. In one embodiment, the generative AI model is a neural network including an input embedding layer, one or more transformer blocks, and an output layer over the space of legal moves. The input embedding layer maps board state features and personality features into a joint latent representation. Each transformer block comprises multi-head self-attention, feed-forward sublayers, and normalization operations. The output layer projects the latent representation to logits for each possible move. The server defines a loss function such as cross-entropy loss between the predicted move distribution and the one-hot encoded expert move, optionally combined with a regularization term that ties the latent style representation to personality labels.

The server uses the matrix computation devices to perform training. The server loads training data batches into GPU memory and performs forward propagation to compute logits and probabilities. The server computes the loss and uses backpropagation to calculate gradients with respect to model parameters. The server applies an optimization algorithm such as Adam to update parameters, using learning rate, momentum, and weight decay parameters stored in configuration. The server repeats passes over the training dataset and monitors validation metrics. When the validation loss converges or a stopping criterion is met, the server stores the trained generative AI model as an inference model in a model repository.

The server deploys the inference model in an inference execution environment such as a model serving framework or application server. The server configures the environment to accept input tensors over an application programming interface, execute the inference model on GPU or CPU, and return output probabilities. The server further configures batching and concurrency limits to efficiently utilize computational resources. Through these configurations, the server reduces latency and increases throughput when multiple terminals request moves concurrently.

The server provides a network-accessible application interface for the terminal. The terminal executes an application, for example a mobile application implemented using a user interface framework, that displays a board, pieces, menus, and controls. The user selects a game type, an expert profile, and optionally difficulty or style preferences. The terminal transmits the selection to the server using a request message containing a game type identifier, expert identifier, and user identifier. The server creates a new match session, allocates a session identifier, initializes an internal game state object, and returns the initial board configuration and the session identifier to the terminal.

During gameplay, the user manipulates pieces on the terminal display. The terminal converts a user move into a standardized move code, such as from a source coordinate to a destination coordinate. The terminal transmits this move code together with the session identifier to the server. The server locates the corresponding match session, updates the internal game state using rule-checking logic, and detects whether the user's move is legal. If the move is legal, the server encodes the new board state into an input tensor and concatenates the expert's personality vector and any user-selected difficulty or style modifiers.

The server sends this input tensor to the inference model. The inference model executes as a sequence of deterministic linear algebra operations on the matrix computation devices. The model produces logits, which the server transforms into a probability distribution using a softmax function. The server can adjust this distribution using an inference temperature parameter, a top-k selection threshold, and a mask of illegal moves. By modifying the temperature and top-k parameters according to difficulty and style settings, the server dynamically controls exploration versus exploitation behavior. The server then selects a move, for example by choosing the highest-probability legal move or by sampling proportionally to the probabilities. This selection procedure does not simply automate human judgment but applies a high-dimensional transformation learned from expert data that cannot be feasibly performed manually.

The server applies the selected move to the game state and records the move in the storage apparatus as part of the move sequence. The server returns the AI move and updated board state to the terminal. The terminal updates the visual representation, animates piece movements, and displays auxiliary information such as clocks or move lists. The user can observe the expert-style behavior, which reflects subtle personality characteristics encoded in the model's parameters and personality vectors.

After a match concludes, the server stores full match information. The server then executes an analysis evaluation program. In one embodiment, the server launches a board game engine process and communicates with it using a text-based protocol. The server replays the recorded game move by move, and at each position instructs the engine to compute an evaluation with a given search depth or time constraint. The engine returns evaluation scores and recommended best moves. The server compares, for each move, the evaluation before and after the move, and also compares the played move against the engine's top recommended moves. The server applies specific numeric thresholds, for example centipawn thresholds or win probability deltas, to classify a move as excellent if it closely matches the engine's principal variation, as inferior if it significantly worsens the position, or as ingenious if it departs from typical engine choices yet still yields a favorable evaluation pattern.

The server aggregates these classifications and evaluation values into evaluation information. The server generates statistical information, such as distributions of excellent, inferior, and ingenious moves by phase of the game, by opening family, or by type of position. The server computes improvement candidate information, such as recurring tactical themes where inferior moves appear, or structural weaknesses frequently exploited. The server then composes feedback information that includes the evaluation information, statistics, and recommendations. This feedback information is formatted, for example, as structured records that can be visualized in a web dashboard or in a report viewer.

The server also uses the evaluation information to update the generative AI model. The server constructs secondary training targets using classifications from the analysis evaluation program. For instance, the server can weight positions containing excellent moves higher in subsequent training, or penalize model tendencies that align with systematically inferior moves. The server augments the training dataset by adding labels indicating move quality and by increasing the diversity of positions through data augmentation techniques such as board mirroring or slight variation of time contexts. The server retrains or fine-tunes the generative AI model periodically using this enriched dataset, thereby aligning the model with both expert examples and engine-based quality assessments. This closed loop, from inference to analysis to retraining, improves prediction accuracy and move quality over time while reusing existing computational infrastructure efficiently.

The terminal can present a review display mode. In this mode, the terminal requests evaluation information from the server for a selected match. The server returns move-by-move annotations, evaluation scores, and suggestions. The terminal displays the game stepwise, overlays color-coded indicators for excellent, inferior, and ingenious moves, and provides textual comments drawn from the feedback information. The user can navigate through moves, compare engine-recommended lines, and observe where the expert-style AI deviated from engine-optimal play.

The system improves computer technology in multiple ways. By enforcing a unified schema and a specific data flow from acquisition through preprocessing, training, inference, analysis, and retraining, the server reduces redundant data storage, lowers preprocessing overhead, and enables efficient indexing and retrieval. By using personality-conditioned features and transformer-based architectures, the generative AI model offers higher predictive accuracy for expert-specific styles compared to conventional generic engines. Because the server dynamically adjusts inference conditions in real time according to user-specified difficulty and style parameters, the system can reuse a single model instance rather than maintain multiple static models, thereby reducing memory footprint and communication overhead. By integrating post-game analysis into the training loop, the server systematically improves model performance using machine-generated labels that are not limited by human evaluation capacity, leading to more accurate and robust style representation.

The system does not merely automate human selection of moves. Instead, the server executes non-conventional processing steps such as encoding expert personality as high-dimensional features, conditioning the generative model on these features, and using engine-based classifications as secondary supervision signals. These technical measures improve the quality of model predictions and the efficiency of resource usage in a networked inference environment. Because the model's operations consist of specialized tensor transformations and attention mechanisms tuned for the board representation and personality features, the server achieves reduced latency and increased throughput in generating moves when compared with naïve rule-based or purely search-based engines that recompute evaluations from scratch for every query.

In an alternative embodiment, the server may implement a different neural network architecture, such as a convolutional neural network operating on board grids combined with recurrent or attention layers for move sequences. In another embodiment, the server may use reinforcement learning techniques, wherein the server defines a reward signal based on engine evaluations and expert-style similarity metrics, and updates the model using policy gradient or value-based methods. In yet another embodiment, the server may partition the generative AI model into submodels specialized by game phase, and select among submodels at inference time according to game phase detection logic. In each case, the server maintains the core workflow of structured acquisition of expert data, generation of a generative AI model, management of session-aware real-time inference, integration of post-game analysis, and feedback-based refinement of the model.

A prompt sentence example that the user can supply to a separate generative AI model in order to design or document such a system is as follows:
“Explain step by step how a server can use the past match data and personality of a professional board game player to train a generative AI model that predicts the player's next move, and show how the terminal and the user interact with this model during an online match.”

Another prompt sentence example is as follows:
“Please explain how to use the past match data of a professional chess player so that an AI can predict the player's next move, and show how to implement this using TensorFlow or PyTorch.”

By implementing the above structures and operations, the server, the terminal, and the user collectively realize a system in which the generative AI model is tightly integrated with a specialized data pipeline, an inference environment, and an analysis-feedback loop. This integrated configuration improves processing speed, prediction accuracy, and data management efficiency in comparison to conventional systems that treat data collection, AI inference, and game analysis as separate, loosely connected components.

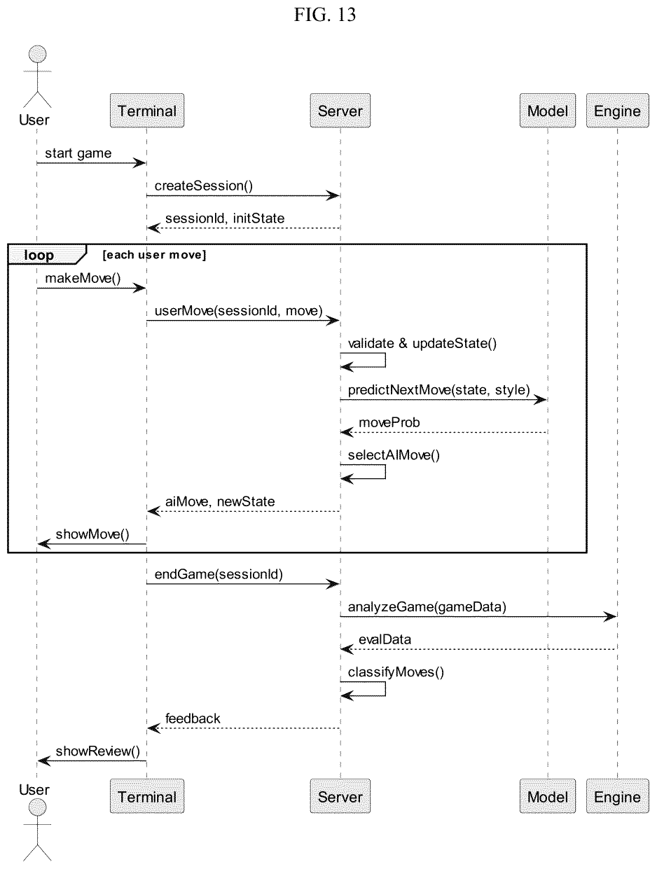

The following describes the processing flow using FIG. 13.

### Step 1:

The server acquires expert data from an external information source.

The server receives, as input, expert identifiers, game type conditions, and access parameters for an external information providing apparatus. The server sends network requests using a communication protocol to obtain past match records and personality-related metadata. The server parses responses in formats such as structured text or semi-structured data into internal records, extracting move sequences, results, timestamps, and style descriptors. The server outputs structured records for experts, games, and moves, each tagged with an expert identifier and game identifier.

### Step 2:

The server stores the acquired expert data in a structured database.

The server takes, as input, the structured expert, game, and move records generated in Step 1. The server opens a connection to an information storage apparatus, creates or updates tables for experts, games, moves, and personality features, and executes insert or update operations for each record. The server performs data normalization, such as mapping text-based move notation to numeric indices and normalizing player names to expert IDs. The server outputs persistent, indexed database entries that allow efficient retrieval by expert, game type, and other attributes.

### Step 3:

The server preprocesses the stored expert data for model training.

The server retrieves, as input, game and move records and associated personality features from the database according to configured filters such as game type or date range. The server removes invalid or incomplete records, filters out games that do not meet length or quality criteria, and sorts moves in chronological order. The server encodes each game position into a numerical tensor, including piece placements, side to move, game phase, and optional timing information, and concatenates a personality feature vector corresponding to the expert. The server also encodes the expert's move as a target label. The server outputs training samples consisting of input tensors and corresponding move labels.

### Step 4:

The server initializes and configures the generative AI model.

The server receives, as input, model architecture parameters, such as the number of layers, hidden sizes, and attention heads, and the dimensionality of board and personality features.

The server constructs a neural network including input embedding layers, internal layers such as transformer blocks or other sequence-processing layers, and an output layer mapping to the move space. The server initializes model parameters with random or preexisting values and allocates model data structures on a matrix computation apparatus. The server outputs an untrained generative AI model ready to accept training data.

### Step 5:

The server trains the generative AI model using the preprocessed data.

The server loads, as input, batches of training samples produced in Step 3 and the initialized model from Step 4. The server performs forward propagation by applying the model to each batch, computing logits and probability distributions over possible moves. The server computes a loss function, for example cross-entropy between predicted distributions and target move labels, and may add regularization terms tied to personality consistency. The server performs backpropagation to compute gradients of the loss with respect to model parameters and updates the parameters using an optimization algorithm. The server iterates over multiple epochs, monitoring validation performance, and stops when a convergence or stopping criterion is met. The server outputs a trained inference model with parameters tailored to expert play styles.

### Step 6:

The server deploys the trained inference model in an execution environment.

The server receives, as input, the trained model parameters from Step 5 and deployment configuration settings such as batch size, device allocation, and endpoint definitions. The server exports the model to a serving-compatible format, loads it into an inference execution environment, and configures network endpoints to accept inference requests. The server sets policies for batching, timeouts, and logging. The server outputs a running inference service capable of receiving encoded game states and returning move probability distributions.

### Step 7:

The user initiates a new game session via the terminal.

The user selects, as input, a game type, an expert profile, and optionally difficulty or style preferences using the terminal interface. The terminal collects these selections and the user identifier and packages them into a session request message. The terminal sends the message to the server. The terminal outputs a request containing the user's choices and waits for a session initialization response.

### Step 8:

The server creates a match session and returns initial game data.

The server receives, as input, the session request from the terminal including game type, expert identifier, and user settings. The server allocates a session identifier, initializes an internal game state according to the selected game rules, and associates the session with the chosen expert and generative AI model. The server records initial metadata, such as start time and configuration parameters, in the storage apparatus or an in-memory session store. The server outputs a response containing the session identifier, initial board position, and any relevant session options to the terminal.

### Step 9:

The terminal displays the initial game state to the user.

The terminal receives, as input, the initial board configuration and session identifier from the server. The terminal initializes its internal representation of the board, pieces, clocks, and move history, and stores the session identifier locally. The terminal renders the board and user interface elements on the display, showing the ready state for the user's first move. The terminal outputs a visible initial game screen and input readiness for the user.

### Step 10:

The user inputs a move on the terminal.

The user interacts, as input, with the terminal's user interface by tapping or dragging a game piece from one location to another. The terminal interprets the touch or pointer events, verifies that the input corresponds to a syntactically valid move within board boundaries, and converts the move into a standardized move code including source and destination coordinates and, where applicable, promotion or special move information. The terminal outputs a move message containing the move code, session identifier, and timestamp for transmission to the server.

### Step 11:

The server validates and applies the user's move.

The server receives, as input, the move message including the session identifier and move code from the terminal. The server retrieves the associated match session state, reconstructs or accesses the current game position, and uses rules for the selected game to check whether the move is legal. If the move is illegal, the server may generate an error response. If the move is legal, the server updates the internal game state data structures to reflect the move, updates move counters and turn information, and appends the move to the move sequence in the storage apparatus or session record. The server outputs an updated game state ready for AI move computation.

### Step 12:

The server encodes the updated game state for inference.

The server takes, as input, the updated game state from Step 11, the expert's personality feature vector, and any user-specified difficulty and style parameters. The server transforms the board configuration into an input tensor by mapping each piece and square to feature channels, encoding side-to-move and other status bits, and incorporating time-related features where relevant. The server concatenates or otherwise combines this state representation with the personality vector and with parameters that modulate inference conditions, such as a difficulty scaling factor. The server outputs a composite input tensor conforming to the generative AI model's input specification.

### Step 13:

The server obtains a move distribution from the generative AI model.

The server sends, as input, the composite input tensor from Step 12 to the deployed inference model in the execution environment. The model performs internal linear algebra operations, including matrix multiplications and nonlinear activations, to propagate the input through its layers. The server receives, as intermediate output, logits over the move space, and converts them into probabilities using a softmax function. The server may then apply adjustment operations, such as scaling probabilities by a temperature value or filtering by top-k moves. The server outputs an adjusted probability distribution over legal candidate moves.

### Step 14:

The server selects the AI move and updates the game state.

The server receives, as input, the probability distribution of candidate moves from Step 13 and the set of legal moves available in the current position. The server removes any illegal moves from the distribution and applies a selection rule, such as choosing the highest-probability move or sampling stochastically according to probabilities, potentially modified by difficulty settings. The server applies the selected move to the internal game state, updates move history and clocks, and stores the move in the storage apparatus. The server outputs the selected AI move and the corresponding updated game position.

### Step 15:

The server sends the AI move and updated position to the terminal.

The server takes, as input, the selected AI move and updated game position from Step 14.

The server encodes the AI move into a standardized move code and the position into a compact position representation suitable for transmission. The server packages these into a response message associated with the session identifier and sends the message to the terminal over the communication network. The server outputs a network response that informs the terminal of the AI's move and the new board state.

### Step 16:

The terminal displays the AI move and continues the game.

The terminal receives, as input, the AI move code and updated board state from the server.

The terminal updates its internal representation of the board to reflect the AI's move, updates clocks and move lists, and re-renders the display. The terminal may animate the movement of the AI's piece to visually indicate the move to the user. The terminal then accepts further user input for the next move. The terminal outputs an updated game screen reflecting the new position and prepares for the next interaction.

### Step 17:

The server records match progress and final results.

The server receives, as input, incremental move information from Steps 11 and 14, as well as a termination condition when the game ends, such as checkmate, resignation, or draw conditions. The server stores the complete move sequence, time usage per move, and final result in the information storage apparatus, associating them with the expert identifier, user identifier, and session identifier. The server computes summary statistics for the match, such as total duration and number of moves. The server outputs a finalized match record that can be used for later analysis and model updates.

### Step 18:

The server analyzes the recorded match using an evaluation program.

The server retrieves, as input, the finalized match record from Step 17. The server replays the game move by move, sending each intermediate position to an analysis evaluation program such as a game engine. The server requests evaluation scores and best-move suggestions from the program. The server then compares, for each move, the position evaluation before and after the move and, where applicable, compares the played move's evaluation with the evaluation of the program's recommended move. The server applies numeric thresholds and rules to classify moves as excellent, inferior, or ingenious. The server outputs move-level evaluation information, including classifications and evaluation values.

### Step 19:

The server aggregates evaluation information and generates feedback.

The server takes, as input, the move-level evaluation information from Step 18 and related metadata such as game type and opening category. The server aggregates the information to compute statistical measures, including frequencies of each classification by game phase and patterns of recurring weaknesses. The server compiles improvement candidate information, such as common error motifs or positions where alternative strategies are recommended. The server formats this information as feedback information suitable for display or reporting. The server outputs feedback information associated with the expert and the specific match.

### Step 20:

The terminal presents review and feedback information to the user.

The terminal requests, as input, feedback information for a selected match, such as a recently completed session, from the server. The terminal receives the feedback information, including evaluations, statistics, and recommendations. The terminal integrates this information into a review interface that allows the user to step through each move, view classification labels and evaluation scores, and see suggested alternatives. The terminal outputs a review screen where the user can visually and interactively examine both the user's moves and the AI's expert-style moves together with their assessments.

### Step 21:

The server updates the generative AI model based on analysis results.

The server receives, as input, aggregated evaluation information over multiple matches and the existing generative AI model parameters. The server constructs updated training datasets by associating positions with quality labels and by emphasizing examples of excellent and ingenious moves while reducing the influence of systematically inferior moves. The server may also perform data augmentation by transforming positions or altering contextual features. The server re-executes training procedures similar to those in Step 5, using the evaluation-informed data to adjust model parameters. The server outputs a refined generative AI model that better reflects expert style and engine-evaluated quality across accumulated match data.

### Step 22:

The user or a system designer generates a prompt sentence for documentation or configuration.

The user prepares, as input, a natural language prompt sentence intended for a separate generative AI model to obtain design or implementation guidance about the system. The user may, for example, enter a sentence such as: “Explain step by step how a server can use the past match data and personality of a professional board game player to train a generative AI model that predicts the player's next move, and show how the terminal and the user interact with this model during an online match.” or “Please explain how to use the past match data of a professional chess player so that an AI can predict the player's next move, and show how to implement this using TensorFlow or PyTorch.” The user submits this text to a separate generative AI system. The output of this interaction can be used as reference material for configuring or extending the server and terminal behavior, but does not alter the core processing steps executed by the described system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented game systems that utilize artificial intelligence opponents primarily focus on static difficulty settings and fixed strategy profiles. In many existing systems, an artificial intelligence engine is trained once on generic data and then deployed as a monolithic module that does not adapt its internal behavior in a fine-grained manner at runtime. As a result, these systems exhibit several technical problems.

First, such systems typically separate an evaluation engine, a user interface, and any higher-level “persona” logic in an ad hoc manner, without a unified control mechanism. The data flow from historical match databases to the inference engine is often limited to offline training; at runtime, the artificial intelligence opponent does not exploit accumulated interaction data or dynamically updated configuration information. This architecture constrains the ability of the processing circuitry to adjust internal inference conditions or search conditions on the basis of real-time contextual signals, such as user behavior or user state. Consequently, the computational resources are not used efficiently, and the user receives responses that are not tuned to the user's actual skill level or current state.

Second, while some systems attempt to use prompt-based generative models, they tend to use prompts only to generate natural language outputs, without structurally integrating prompt sentences into the control path of the artificial intelligence opponent itself. That is, prompt sentences are not used as first-class control inputs that directly drive the parameterization of the underlying opponent model or the configuration of state representation formats and search policies. This leads to a technical limitation where a generative artificial intelligence model operates as a loosely coupled front-end, and the core decision logic of the opponent remains largely static and opaque.

Third, conventional systems do not effectively exploit multimodal sensor data, such as image data and audio data from an information terminal, to adapt computational behavior. Existing emotion-aware or context-aware applications often apply emotion recognition only at an application layer to select content, while leaving the underlying inference engine unchanged.

In the context of interactive game opponents, this means the engine's search depth, randomness, and evaluation thresholds are not adjusted at the level of algorithmic configuration. Therefore, the processing load cannot be dynamically balanced against user state, and the system cannot provide a technically optimized interaction loop that minimizes unnecessary computations while maintaining a desired interaction quality.

Fourth, post-match analysis in known systems generally consists of simple statistical summaries or engine evaluations presented to the user as static reports. The processing circuitry does not typically feed back aggregated match history data, including classified move quality and user behavior patterns, into the parameter space of the opponent model or into the generation conditions for control instructions. This lack of a closed feedback loop prevents continuous technical refinement of the model's behavior over time based on real usage data, and hinders the system from evolving into more efficient and more accurate behavior generators.

Accordingly, there is a need for a computer-implemented system that integrates (i) structured acquisition and feature extraction of past match history information, (ii) training and configuration of a generative artificial intelligence model, (iii) prompt-sentence-based control of an opponent model's behavior, (iv) real-time emotion-based adjustment of inference and search conditions, and (v) continual updating of model parameters and prompt generation conditions based on accumulated interaction data. Such a system should technically improve the way processing circuitry orchestrates data flows and control signals between databases, opponent models, generative artificial intelligence models, sensor-processing modules, and user interfaces, thereby providing a more adaptive, resource-efficient, and context-sensitive artificial intelligence opponent.

The specific processing by the specific processing unit 290 of the data processing device 12 in Application Example 2 is realized by the following means.

The present invention provides a server comprising a processor and a storage device that cooperate to acquire past match history information and associated behavior tendency information for multiple players from the storage device or external information sources via an information terminal, normalize the past match history information, extract feature information therefrom, and generate and store a training data set based on the feature information, to train a generative artificial intelligence model by applying a machine learning algorithm to the training data set so that internal parameters of the generative artificial intelligence model are set to constitute a match opponent model capable of generating match behavior output reflecting the behavior tendency information, to generate prompt sentences including instructions that control the match opponent model to perform behavior imitating the behavior tendency information and to generate explanation information, and to input the prompt sentences to the generative artificial intelligence model so as to control behavior of the match opponent model during a match, to acquire match start instructions and game type information input by a user from a match user interface executed on the information terminal, select the match opponent model according to the game type information, generate prompt sentences including instructions to start a match with the selected match opponent model, and input the prompt sentences to the generative artificial intelligence model so as to cause a match between the user and the match opponent model to be started, to acquire image data and audio data of the user from an imaging device and an audio acquisition device of the information terminal, perform emotion estimation processing on the basis of the image data and the audio data to identify an emotional state of the user, to store setting information in which a match difficulty level and a behavior pattern of the match opponent model are associated with different emotional states, determine, based on the identified emotional state, current setting information including a match difficulty level and a behavior pattern, change inference conditions or search conditions of the match opponent model in accordance with the current setting information, generate prompt sentences including instructions that cause the generative artificial intelligence model to have the match opponent model adopt behavior reflecting the current setting information, and input the prompt sentences to the generative artificial intelligence model so as to dynamically adjust match behavior of the match opponent model, to acquire, during the match, position information of a current match situation and user turn information transmitted from the information terminal, calculate, by using the match opponent model, response move candidates and evaluation information for the current match situation, select, based on a predetermined evaluation criterion, one of the response move candidates as a response move, output the response move and explanation information based on the evaluation information to the information terminal, and, after completion of the match, perform analysis processing on match history data including the position information and moves to classify user moves into categories based on changes in an evaluation value, generate feedback information including classification results, and accumulate both the match history data and the feedback information in the storage device, while updating at least one of the internal parameters of the match opponent model and generation conditions of the prompt sentences based on match results between the match opponent model and a plurality of users so as to continuously improve match behavior reflecting the behavior tendency information. This enables an integrated, computer-implemented architecture in which the processor uses prompt sentences as structured control inputs to a generative artificial intelligence model, dynamically reconfigures inference and search conditions of a match opponent model in response to real-time emotional state estimation and game context, and closes a feedback loop that refines model parameters and control instructions based on accumulated interaction data, thereby improving the technical functioning of the artificial intelligence opponent subsystem and the overall efficiency and adaptability of the game processing system.

The term “system” refers to a combination of one or more hardware devices and one or more software components that cooperate to perform information processing, including at least a processor, a storage device, and an interface to an information terminal.

The term “server” refers to an information processing apparatus including at least one processor and at least one storage device, configured to execute programs, process data, and communicate with one or more information terminals over a communication network.

The term “processor” refers to a hardware computation unit, such as a central processing unit or a dedicated processing circuit, that executes machine-readable instructions to perform arithmetic operations, control operations, and data processing operations.

The term “storage device” refers to a non-transitory computer-readable medium, such as a semiconductor memory, a magnetic storage medium, or an optical storage medium, that stores programs, parameters, feature data, match history data, and other information used by the processor.

The term “information terminal” refers to an electronic device operated by a user, such as a portable terminal or a head-mounted display device, that includes at least a display unit, an input unit, and communication functionality for interacting with the server.

The term “user interface” refers to a software-implemented presentation layer and input layer executed on the information terminal, through which a user can view information, perform operations, and issue commands such as match start instructions and game selections.

The term “match history information” refers to digital data representing past matches, including at least move sequences, position states, outcomes, timestamps, and associated metadata for each match.

The term “behavior tendency information” refers to information derived from match history information that characterizes patterns of behavior of a player, including preferences for particular openings, strategies, risk levels, and typical responses in specific situations.

The term “feature information” refers to numerical or symbolic descriptors extracted from match history information or current match states, including evaluations of positions, piece configurations, material balances, structural motifs, and other measurable attributes.

The term “training data set” refers to a structured collection of input-output pairs or labeled examples, generated from feature information and match history information, and used to train a machine learning model.

The term “machine learning algorithm” refers to a computational procedure, such as a neural network training method, a gradient-based optimization method, or another statistical learning method, that adjusts internal parameters of a model to minimize a loss function using training data.

The term “generative artificial intelligence model” refers to a machine learning model, such as a neural network or a probabilistic model, that generates outputs including text, moves, explanations, or configuration data, in response to an input that may include prompt sentences and state representations.

The term “match opponent model” refers to a configuration of the generative artificial intelligence model and related inference mechanisms that is capable of generating moves and behavior patterns as an artificial opponent in a match.

The term “internal parameters” refers to adjustable numerical values within the generative artificial intelligence model, such as weights, biases, and other model coefficients, that determine the model's behavior when processing input data.

The term “prompt sentence” refers to a machine-readable text string or sequence of tokens that encodes instructions, constraints, or contextual information provided to a generative artificial intelligence model to control or influence the model's output.

The term “game type information” refers to information indicating a kind or category of game, such as a type of board game, associated rules, or a representation scheme, selected by a user or preconfigured by the system.

The term “match start instruction” refers to an input operation or signal generated by the user through the user interface, instructing the system to initiate a match between the user and a match opponent model.

The term “image data” refers to digital data corresponding to visual information acquired by an imaging device, including frames or sequences of frames of the user's face or surroundings.

The term “audio data” refers to digital data corresponding to sound information acquired by an audio acquisition device, including the user's speech, vocal reactions, and other audible signals.

The term “imaging device” refers to a hardware component, such as a camera or an image sensor module, included in or connected to the information terminal, that captures image data.

The term “audio acquisition device” refers to a hardware component, such as a microphone or an audio sensor, included in or connected to the information terminal, that captures audio data.

The term “emotion estimation processing” refers to processing performed by software or hardware that analyzes image data and audio data to infer an emotional state of the user, such as confusion, relaxation, confidence, or frustration.

The term “emotional state” refers to a classification or representation of a user's affective condition, inferred from sensor data, and including categories such as confused, relaxed, confident, and frustrated.

The term “match difficulty level” refers to a parameter or set of parameters indicating the relative strength, aggressiveness, or complexity of the behavior of the match opponent model.

The term “behavior pattern” refers to a set of characteristics or tendencies controlling how the match opponent model chooses moves, presents explanations, and reacts to user actions, including personas such as educational, neutral, or challenging.

The term “setting information” refers to data that associates different emotional states with specific match difficulty levels and behavior patterns, and that is used to configure inference conditions or search conditions of the match opponent model.

The term “inference conditions” refers to configuration parameters that affect how the generative artificial intelligence model or the match opponent model produces outputs, including temperature, randomness, pruning thresholds, and evaluation horizons.

The term “search conditions” refers to configuration parameters controlling algorithmic search for candidate moves, including search depth, branching factor limits, evaluation bounds, and resource constraints.

The term “position information” refers to data indicating a current state of a game or match, including the arrangement of pieces or tokens, side to move, clocks, and any other state variables necessary to determine legal moves and evaluations.

The term “response move candidate” refers to a potential move generated by the match opponent model in reaction to a current position and a user move, before a final selection is made based on evaluation criteria.

The term “evaluation information” refers to quantitative or qualitative data that assesses a position or a move, including numeric scores, probabilities of winning, or categorized assessments such as advantageous or disadvantageous.

The term “evaluation value” refers to a numerical score or metric assigned to a position or move, representing the estimated favorability of the position for a player.

The term “analysis engine” refers to a computational component, which may be a separate neural network or a rule-based engine, configured to evaluate positions, simulate lines of play, and provide assessments of move quality.

The term “match history data” refers to stored data that records sequences of positions, moves, timestamps, evaluations, and related metadata for completed matches between users and match opponent models.

The term “classification result” refers to the outcome of processing that assigns each user move to one of multiple categories, such as good move, inappropriate move, or clever move, based on analysis of evaluation value changes.

The term “feedback information” refers to data generated by the server that describes assessments of a user's moves, provides guidance, and includes summaries or explanations intended for presentation to the user.

The term “summary information” refers to a condensed representation of a match, generated by the generative artificial intelligence model, that highlights key points, strengths, weaknesses, and recommendations for the user.

The term “state representation format” refers to a structure or encoding used to represent a game state as input to the match opponent model, including vectorized representations, graphs, or other data formats.

The term “search policy” refers to a strategy or algorithmic rule-set employed by the match opponent model to explore possible moves and sequences, including policies used in tree search or other search-based decision procedures.

The term “evaluation criterion” refers to a rule or set of rules that uses evaluation information or evaluation values to select one response move candidate from among multiple candidates.

The term “representative position” refers to a selected position from a match history that exemplifies a particular tactical or strategic feature, or that is used in analysis or feedback as an illustrative example.

The term “plurality of users” refers to two or more distinct user entities that operate respective information terminals and engage in matches with the match opponent model.

The term “interaction data” refers to data accumulated during interaction between users and the system, including match history data, emotion estimation results, feedback usage, and user interface operations.

The term “update of internal parameters” refers to a modification of one or more values within the generative artificial intelligence model or match opponent model performed after initial training, based on additional data or criteria.

The term “generation conditions of the prompt sentence” refers to configuration parameters or rules that define how prompt sentences are constructed, including which instructions are inserted, how context is summarized, and which model behaviors are requested.

In one embodiment, a server cooperates with one or more terminals to implement the claimed system. The server includes at least one processor, a main memory, and a non-transitory storage device. The terminal includes at least one processor, a display, an input device, an imaging device, an audio acquisition device, and a communication interface. The server and the terminal communicate via a communication network such as a packet-switched network using a predefined protocol.

The server executes an operating system and an application stack including a database management system, a machine learning framework, and a game engine back-end. As concrete examples, the server can execute a relational database engine, a machine learning framework such as a deep learning library, and a game logic engine implemented in a server-side runtime. The server stores match history information, behavior tendency information, model parameters, prompt generation rules, and feedback logs in the storage device.

The terminal executes a client application implemented by a graphical engine such as a three-dimensional game engine. The terminal renders a game board, pieces, status indicators, menus, and feedback views on the display. The terminal acquires user inputs via a touch panel, a pointing device, or controllers, and acquires multimodal sensor data via a front-facing camera and a microphone.

The server acquires past match history information and behavior tendency information from the storage device or from external information sources. The server uses a data ingestion module to periodically query external game repositories through an application programming interface. The server stores raw logs in a structured form such as a table where each record includes at least a match identifier, a player identifier, a sequence of positions encoded as vectors, a sequence of moves encoded as categorical indices, time stamps, and outcome labels.

The server normalizes the match history information and extracts feature information. The server uses a preprocessing module implemented, for example, by a numerical computation library, to convert each game state into a fixed-length tensor. The server encodes a board position as a multi-channel matrix, where each channel represents occupancy of a particular piece type or game attribute. The server also computes engineered features such as material balance, piece activity, king safety scores, and pawn structure patterns, expressed as real-valued or integer-valued vectors. The server concatenates these features with contextual features such as move number, time remaining, and result. As a result, the server generates a training data set composed of input vectors and target outputs (for example, expert move labels and outcome values) stored in a format suitable for batch processing by a machine learning framework.

The server trains a generative artificial intelligence model using a machine learning algorithm. In one embodiment, the server constructs a neural network architecture including a state encoder, a policy head, and a value head. The state encoder includes multiple convolutional layers that process the board tensor, optionally combined with residual connections and non-linear activation functions. The policy head outputs a probability distribution over all legal moves using a final softmax layer. The value head outputs a scalar value that predicts expected match outcome from the current state.

The server uses supervised learning and, optionally, reinforcement learning to optimize internal parameters of this model. The server defines a loss function as a weighted sum of a cross-entropy loss between the predicted move distribution and the expert move, a mean-squared error between the predicted outcome value and the actual result, and, if used, an entropy regularization term to control exploration. The server performs gradient-based optimization, such as stochastic gradient descent or adaptive gradient methods, to update the internal parameters. The server executes the training on a computation platform including one or more graphics processing units, thereby accelerating matrix multiplications and convolution operations.

The server configures the trained model as a match opponent model. The match opponent model is registered with metadata identifying the associated behavior tendency information and game type. The server stores the internal parameters and architecture configuration in the storage device, and exposes an inference interface to other modules of the server.

The server uses prompt sentences as structured control inputs to a generative artificial intelligence model that cooperates with the match opponent model. In one embodiment, the generative artificial intelligence model is a sequence-to-sequence neural network or a transformer-based model that processes text tokens. The server generates prompt sentences that include explicit instructions about style, difficulty, persona, and explanatory behavior. Example prompt sentences are:
“Imitate the historical playing style of Expert Player A based on their past match data. Play in a solid, positional manner and explain key strategic ideas when the user requests a hint.” “Configure the opponent model to adopt an educational persona. Use safer moves, avoid complex sacrifices, and provide short explanations after critical turning points.” “Given the current position and the persona of Professional Player B, propose three candidate moves ranked from most to least suitable, and describe the main idea behind each move.”

The server inputs these prompt sentences to the generative artificial intelligence model together with context information such as a summary of recent moves and evaluation trends.

The generative artificial intelligence model outputs control tokens and textual explanations. The server interprets the control tokens as directives for setting search depth, randomness parameters, or hint frequency in the match opponent model, and passes the explanations to the terminal for display. In this way, prompt sentences are not merely narrative text; they are transformed into parameter settings that directly modify inference conditions and search conditions inside the computational pipeline.

The terminal obtains a game selection and a match start instruction from the user. The terminal sends game type information and user identifiers to the server. The server looks up a match opponent model that corresponds to the requested game type. The server generates an initial prompt sentence instructing the generative artificial intelligence model to configure the match opponent model for the selected style and difficulty. The server then binds a newly created match state object to the user session and initializes the board representation and timers.

The terminal captures image data and audio data of the user during the match. The terminal compresses the sensor data and transmits it to the server at predefined intervals. The server performs emotion estimation processing using a dedicated emotion recognition module. In one embodiment, the server uses a vision model with convolutional layers to process facial image patches and an audio model with recurrent or transformer layers to process mel-spectrogram features of the audio data. The server maps the extracted features to emotion labels using a classifier trained with supervised learning. The classifier outputs a probability distribution over emotion classes, and the server selects the highest-probability class as the current emotional state, optionally smoothed over time.

The server maintains setting information that associates emotional states with match difficulty levels and behavior patterns. For example, the server associates a “confused” emotional state with a lower search depth, higher randomness, and an educational persona, and associates a “confident” emotional state with a higher search depth, lower randomness, and a more challenging persona. The server changes parameters such as maximum search depth in the match opponent model, pruning thresholds, and evaluation margins, based on the current setting information. The server also changes the content of prompt sentences to instruct the generative artificial intelligence model to alter explanation style and tone. An example of such a prompt sentence is:
“The user appears confused according to the recent facial and voice analysis. Reduce the effective difficulty to an intermediate level, choose moves that keep the position clear, and provide short educational comments after each major decision.”

By controlling both numerical parameters in the match opponent model and textual instructions in prompt sentences, the server dynamically adapts computational behavior to user state. This technical arrangement improves computational efficiency: when the user is overwhelmed, the server avoids unnecessary deep searches and resource-intensive calculations, while maintaining sufficient strength. When the user is confident and demands a challenge, the server increases search depth and uses more sophisticated evaluations.

The server receives position information and user move information from the terminal. The server encodes the current position into the state representation format used by the match opponent model. The server generates a set of candidate responses by running a search procedure, such as a tree search guided by the policy and value outputs of the neural network.

The server computes evaluation information for each candidate, such as an expected score advantage and tactical risk metrics. The server applies an evaluation criterion, for example selecting the move that maximizes expected outcome subject to persona-specific constraints (such as avoiding excessively punishing moves in an educational mode). The server outputs the selected move to the terminal and optionally attaches explanation text produced by the generative artificial intelligence model.

The terminal renders the move, animates the piece on the board, and displays the explanation text near the board area. The terminal may also display an evaluation bar derived from the evaluation information to visualize the current advantage or disadvantage. The user can request hints or analysis at any time through the user interface. Upon a hint request, the server uses the same state representation and generative artificial intelligence model to produce one or more suggested moves and explanatory text, under control of a prompt sentence such as: “Given the current position, provide the user with one recommended move that is consistent with the persona of Expert Player C, and explain in simple terms why this move is appropriate.”

After the match ends, the server performs an in-depth analysis of the match history data. The server replays the entire sequence of positions and moves using an analysis engine. The server computes an evaluation value for each position and the change in evaluation value caused by each user move. The server classifies each user move into discrete categories such as excellent, good, inaccuracy, mistake, blunder, and clever move using thresholds on the evaluation change. The server stores the classification result, the evaluation values, and representative positions in the storage device.

The server generates feedback information using a generative artificial intelligence model configured by a specialized prompt sentence. An example of such a prompt sentence is: “Summarize this completed game for the user. Highlight three excellent moves, three critical mistakes, and one especially clever idea. Provide concise, actionable advice for future games and refer to the representative positions identified by the analysis engine.”

The generative artificial intelligence model produces summary information that the server sends to the terminal. The terminal displays the summary information along with an interactive replay where the user can step through key positions and view associated commentary. The feedback information is also used by the server to refine the match opponent model. The server aggregates match history data from multiple users, computes aggregate statistics about move outcomes, and adjusts internal parameters through additional training steps. The server may conduct periodic fine-tuning sessions where the match opponent model is retrained using a combination of original expert data and augmented data derived from user matches. The server can also adjust prompt generation conditions, such as which instructions to emphasize for particular game phases, based on observed effectiveness of feedback.

This architecture improves computer technology in several ways. By integrating prompt sentences as control signals that directly affect model parameters and search policies, the server uses generative artificial intelligence not merely to generate human-readable text but to configure and orchestrate complex inference pipelines. This reduces manual configuration overhead and enables fine-grained, contextual optimization of computational resources. By linking emotional state estimation to algorithmic parameters such as search depth and pruning thresholds, the server adjusts computation intensity in real time, thereby reducing unnecessary processing and network traffic while maintaining user-appropriate performance. By continuously updating model parameters and prompt generation rules based on accumulated interaction data, the server incrementally improves prediction accuracy and personalization without requiring offline manual retuning.

The server performs non-conventional sequences of operations that differ from human manual processes. For example, the server encodes game states into high-dimensional tensors, applies convolutional and attention-based layers to derive latent representations, and uses backpropagation with composite loss functions to optimize a large number of parameters. The server also uses non-intuitive mappings between emotion labels and search configurations to improve overall throughput and response time, which human operators could not easily manage in real time.

In alternative embodiments, the server may employ different neural architectures, such as graph neural networks that operate on game state graphs, or recurrent networks that explicitly model time dependencies in user behavior. The emotion recognition module may be deployed partially on the terminal using a lightweight model, thereby reducing communication load by transmitting only classification results or compressed feature vectors to the server. The prompt generation module may include templates and learned components, for example a neural prompt generator that selects and composes instruction phrases based on internal state and historical performance data.

The terminal can be implemented as a portable communication device, a stationary console, or a head-mounted display device. In some embodiments, the terminal performs pre-processing such as downscaling images, extracting facial landmarks, or computing basic audio features before sending data to the server, thereby reducing bandwidth. In other embodiments, the terminal runs a local inference model for simple matches, while offloading heavy analysis and training tasks to the server.

Through these embodiments, the system enables a technical improvement in the way computing resources are orchestrated to implement adaptive, expert-like opponents. The server improves processing speed by dynamically reducing unnecessary search in low-difficulty or low-engagement states, improves accuracy by continuously refining models with aggregated data, and improves data management by structuring match history information and behavior tendencies into formal data structures used for training, inference, and feedback.

The cooperation of a generative artificial intelligence model, a match opponent model, and prompt sentences in the described manner results in a specific, non-abstract configuration that enhances the functioning of the server and the terminal beyond a mere automation of human decision-making.

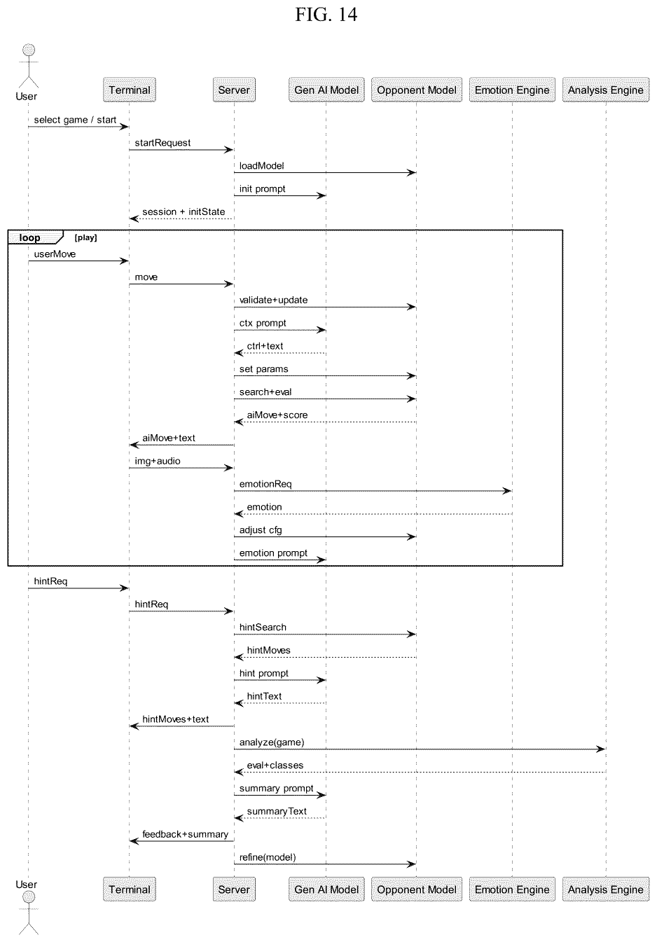

The following describes the processing flow using FIG. 14.

### Step 1:

The server acquires past match history information and behavior tendency information.

The server receives, as input, raw match logs and player metadata from a storage device and/or external data sources accessed via an application programming interface. The server parses the raw logs into structured records, normalizes identifiers, and filters out incomplete records. The server outputs normalized match records where each record includes at least a game identifier, a sequence of moves, position states, outcomes, and player identifiers.

### Step 2:

The server generates a training data set from the normalized match records.

The server receives, as input, the normalized match records from Step 1. The server encodes each position into a fixed-length state representation (for example, a multi-channel tensor) and computes feature vectors such as material balance, positional scores, and contextual indicators. The server pairs each state representation with a target move label and an outcome label. The server outputs a training data set consisting of input feature tensors and associated target outputs stored in a machine-learning-friendly format.

### Step 3:

The server trains a match opponent model as a generative AI model configuration.

The server receives, as input, the training data set from Step 2. The server initializes a neural network architecture including an encoder, a policy head, and a value head, and defines a loss function combining cross-entropy for move prediction and mean-squared error for outcome prediction. The server iteratively performs forward propagation to compute predictions, backward propagation to compute gradients, and parameter updates using an optimization algorithm. The server outputs trained internal parameters and a registered match opponent model instance stored in the storage device.

### Step 4:

The server constructs an initial prompt sentence to configure the generative AI model.

The server receives, as input, model metadata such as associated expert identity, behavior tendency information, and default difficulty settings. The server fills a prompt template with this metadata to create an instruction text, for example: “Imitate the historical playing style of the selected expert, play in a solid style, and provide short explanations when requested.” The server outputs an initial prompt sentence to be sent to the generative AI model for session initialization.

### Step 5:

The terminal acquires a game selection and a match start instruction from the user.

The user selects a game type and an opponent style on the terminal's user interface and actuates a start control. The terminal receives, as input, the user's selections and start instruction from input devices. The terminal packages this information into a start request message including user identifier, game type, and requested opponent style. The terminal outputs the start request to the server via a communication interface.

### Step 6:

The server initializes a match session using the selected match opponent model.

The server receives, as input, the start request from Step 5. The server selects a match opponent model that matches the requested game type and style, associates the model with a new session record, and loads the model parameters into memory. The server attaches the initial prompt sentence from Step 4 to the session context and sends this prompt sentence to the generative AI model. The server outputs a session identifier and initial game state to the terminal.

### Step 7:

The terminal sets up and displays the initial game state.

The terminal receives, as input, the session identifier and initial game state from the server. The terminal initializes local game state variables, constructs a graphical board using a rendering engine, and positions game pieces for the starting position. The terminal outputs a rendered initial game screen and a ready state that allows the user to make the first move.

### Step 8:

The terminal captures user moves and transmits them to the server.

The user selects a piece and a destination cell through the terminal interface. The terminal receives, as input, coordinates or selection events from the input devices. The terminal validates basic move legality locally (for example, correct turn and within-board position), encodes the move into a standardized notation, and bundles it with the current session identifier and local timestamp. The terminal outputs a move message to the server.

### Step 9:

The server updates the authoritative game state and validates the user move.

The server receives, as input, the move message from Step 8. The server applies server-side rule logic to the current authoritative game state to verify that the move is legal and to update the internal board representation. If the move is invalid, the server generates an error response; if it is valid, the server logs the move into the match history data. The server outputs either an error notification or an updated game state to be used for opponent move calculation.

### Step 10:

The server prepares contextual information and a prompt sentence for the generative AI model.

The server receives, as input, the updated game state, the recent move history, and the current persona and difficulty settings for the session. The server summarizes the recent move sequence and evaluation trend into a short text context and appends it to the stored style prompt. The server creates a current prompt sentence such as: “Given the current position and the persona of the selected expert, propose candidate moves and explanations consistent with the current difficulty level.” The server outputs the contextual prompt sentence and structured state representation to the generative AI model.

### Step 11:

The generative AI model produces control information and explanation text, and the server interprets it.

The server provides, as input to the generative AI model, the prompt sentence and the contextual information from Step 10. The generative AI model produces output tokens representing, for example, suggested move identifiers, configuration adjustments (such as search depth hints), and natural language explanations. The server parses this output into structured control fields and explanation text. The server outputs extracted candidate moves, recommended parameter changes, and explanation strings to the match opponent model controller.

### Step 12:

The server computes candidate moves and selects a response using the match opponent model.

The server receives, as input, the updated game state, candidate move identifiers, and any recommended parameter changes from Step 11. The server configures the match opponent model by applying parameter changes such as updated search depth or randomness. The server runs a search procedure guided by the policy and value outputs of the match opponent model to evaluate available moves. The server combines the model evaluations with the candidate list and selects a final response move according to an evaluation criterion. The server outputs the response move and associated evaluation information to the terminal.

### Step 13:

The terminal displays the opponent move and associated explanation.

The terminal receives, as input, the response move and evaluation information from Step 12 along with explanation text produced by the server. The terminal updates its local game state, animates the movement of the opponent's piece on the board, and refreshes any status indicators. The terminal displays the explanation text in a designated area, and optionally updates an evaluation bar based on the evaluation information. The terminal outputs an updated visual game state to the user.

### Step 14:

The terminal captures user image data and audio data during the match.

The terminal receives, as input, continuous sensor signals from the imaging device and the audio acquisition device while the match screen is active. The terminal periodically samples frames and audio snippets, compresses them, and associates them with the current session identifier and timestamp. The terminal outputs batches of image data and audio data to the server via the communication interface.

### Step 15:

The server estimates the emotional state of the user from the sensor data.

The server receives, as input, the image data and audio data from Step 14. The server applies a vision model to extract facial features and an audio model to extract prosodic features, then feeds the features into an emotion classifier. The server calculates, for each time slice, a probability distribution over predefined emotional states and selects one as the current emotional state, optionally applying temporal smoothing. The server outputs the current emotional state and confidence measure to a configuration control module.

### Step 16:

The server adjusts difficulty and persona based on the emotional state and generates an updated prompt sentence.

The server receives, as input, the current emotional state and the existing session configuration from Step 15. The server consults setting information that maps emotional states to target difficulty levels and behavior patterns, and determines a new configuration such as new search depth, randomness, and persona labels. The server updates internal configuration structures for the match opponent model and constructs a modified prompt sentence, such as: “The user appears confused; lower the difficulty and adopt an educational persona with more explanatory comments.” The server outputs the updated configuration parameters and updated prompt sentence to be used in subsequent calls to the generative AI model and opponent model.

### Step 17:

The terminal processes user hint requests and forwards them to the server.

The user activates a hint control on the terminal interface. The terminal receives, as input, the hint activation event and the current local game state. The terminal packages the current position, session identifier, and hint request type into a request message. The terminal outputs the hint request message to the server.

### Step 18:

The server generates hint information using the match opponent model and the generative AI model.

The server receives, as input, the hint request from Step 17 along with the current game state and configuration. The server performs a limited-depth search using the match opponent model to identify one or more strong candidate moves and calculates evaluation information for these candidates. The server prepares a hint-specific prompt sentence such as: “Provide one recommended move for the user in the current position and explain in simple terms why it is a good choice.” The server sends the prompt sentence and candidate move data to the generative AI model, obtains explanation text, and bundles the move suggestions with the explanations. The server outputs the hint moves and explanation text to the terminal.

### Step 19:

The terminal presents hint information to the user.

The terminal receives, as input, the hint moves and explanation text from Step 18. The terminal highlights the recommended move on the board, for example by outlining the suggested origin and destination squares, and displays the explanation text near the board.

The terminal outputs an updated user interface that visually indicates the hint while preserving the current game state for the user to decide the next move.

### Step 20:

The server logs match history data including model configurations and emotional states.

The server receives, as input, all moves, positions, emotional state classifications, and configuration changes throughout the match. The server organizes this information into a structured match history record that includes per-move evaluations, emotional state snapshots, and effective difficulty settings. The server stores this record in the storage device.

The server outputs a persisted match history entry that can be used for later analysis and model refinement.

### Step 21:

The server performs post-match analysis and move classification.

The server receives, as input, the completed match history record from Step 20. The server replays the game using an analysis engine, computes evaluation values for each position, and calculates the change in evaluation value caused by each user move. The server compares these changes against predefined thresholds to classify each move as excellent, good, inaccuracy, mistake, blunder, or clever. The server outputs classified moves, representative positions, and associated evaluation data to a feedback generation module.

### Step 22:

The server generates feedback and summary information using a generative AI model and a prompt sentence.

The server receives, as input, the classification results, representative positions, and evaluation data from Step 21. The server constructs a feedback prompt sentence such as: “Summarize the game for the user, highlight three excellent moves, three critical mistakes, and provide concrete suggestions for improvement, referring to the given key positions.” The server inputs the prompt sentence and structured analysis data to the generative AI model, receives summary text and structured feedback, and formats this information for presentation.

The server outputs feedback information and summary information to the terminal.

### Step 23:

The terminal displays post-match feedback to the user.

The terminal receives, as input, the feedback information and summary information from Step 22. The terminal renders a post-match screen showing a list of key positions, textual commentary, and move classifications, and provides controls for the user to replay the game and inspect specific moves. The terminal outputs an interactive feedback interface that allows the user to review performance and understand suggested improvements.

### Step 24:

The server refines the match opponent model and prompt generation conditions based on aggregated interaction data.

The server receives, as input, multiple match history records and associated feedback usage statistics from many matches and users. The server aggregates the data to compute statistics such as typical error patterns, success rates of particular strategies, and effectiveness of specific personas and difficulty settings. The server uses this aggregated data to perform additional training steps on the match opponent model, adjusting internal parameters to better reflect actual play patterns, and to adjust prompt generation rules, such as which instructions to emphasize in particular contexts. The server outputs updated model parameters and updated prompt generation conditions to the storage device, making them available for future sessions.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

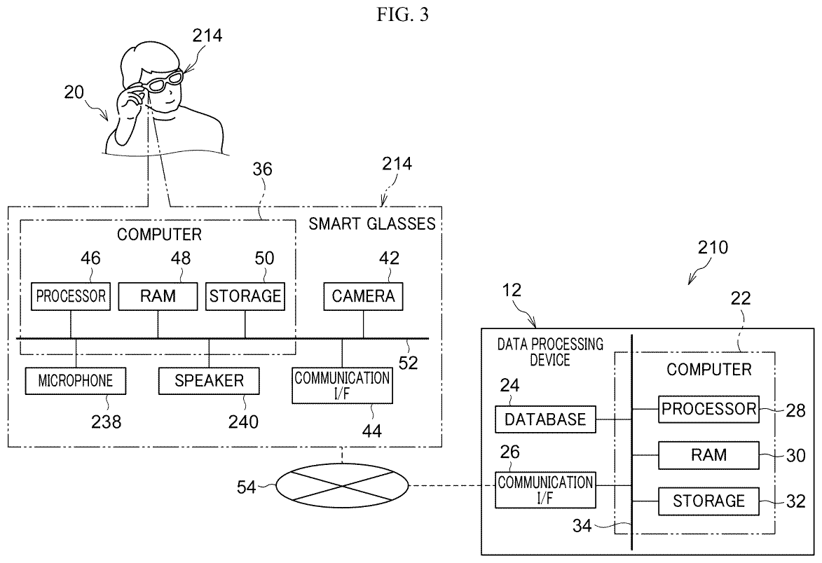

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

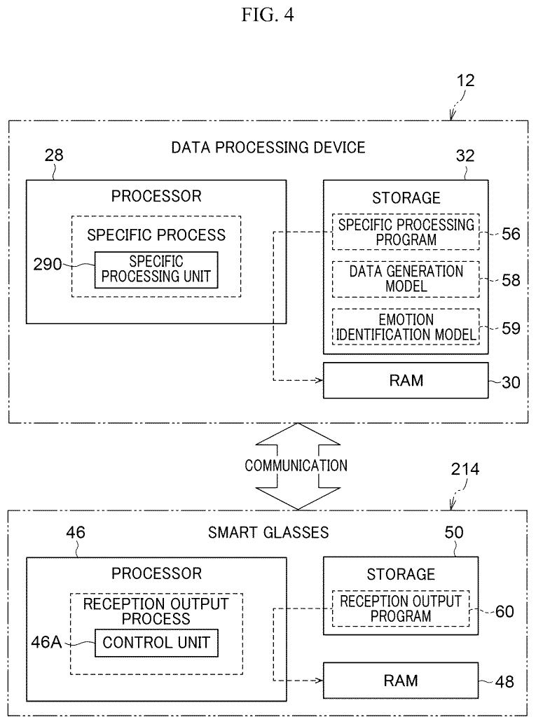

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

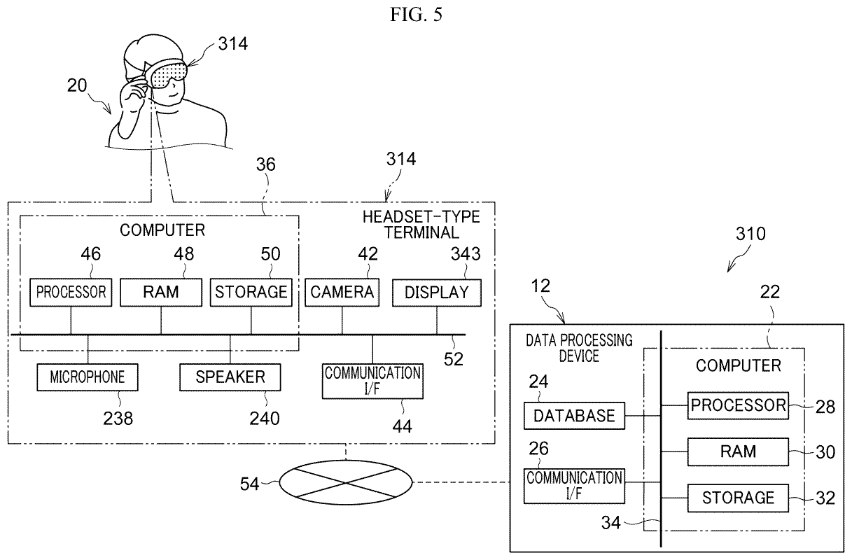

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

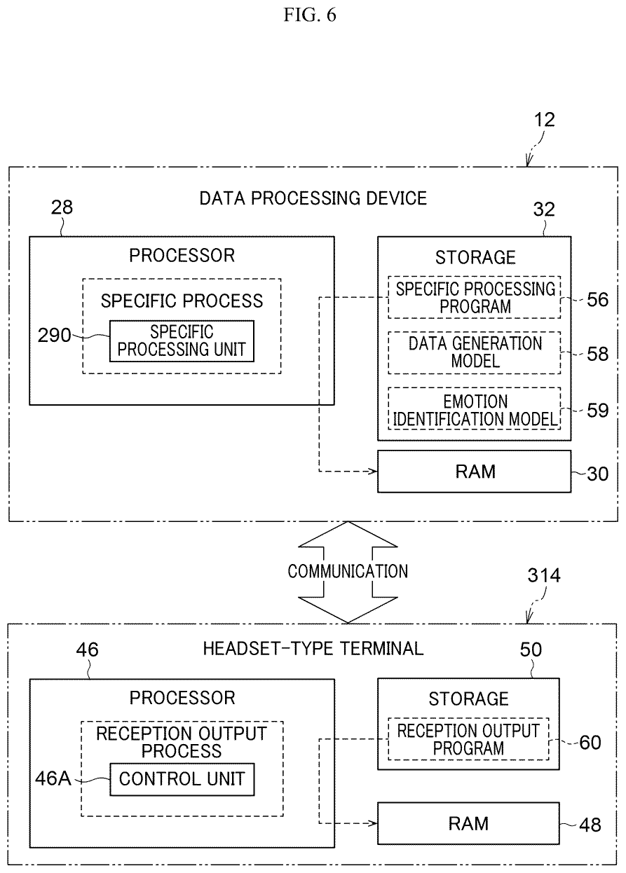

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

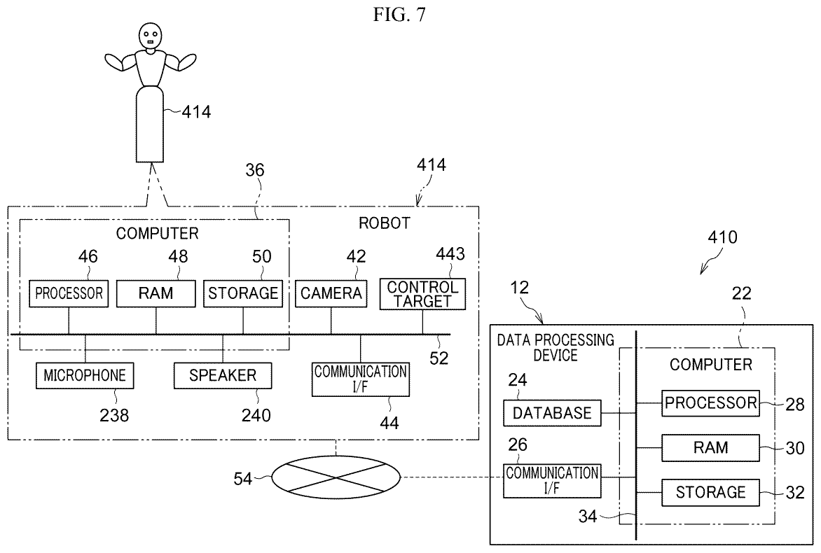

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

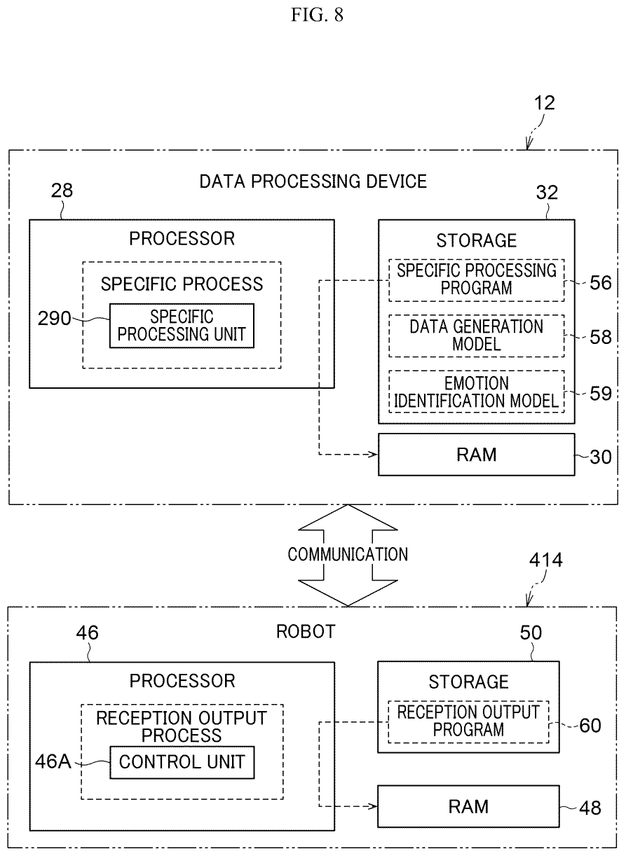

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

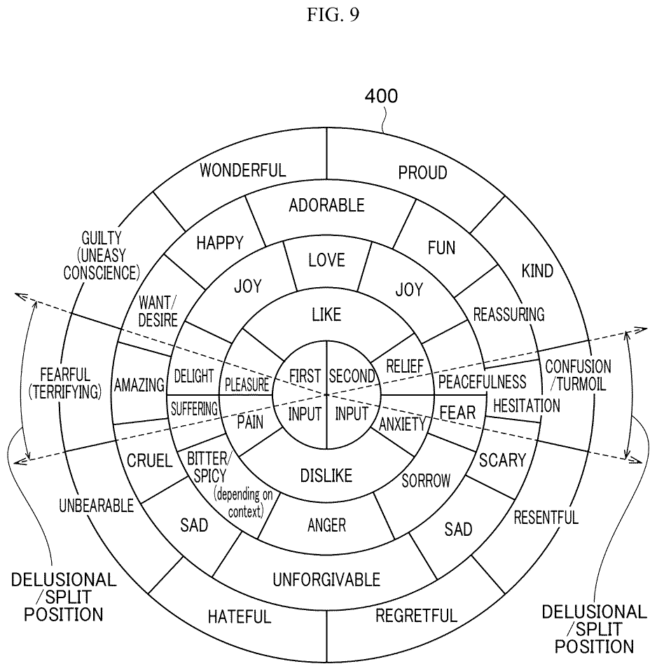

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

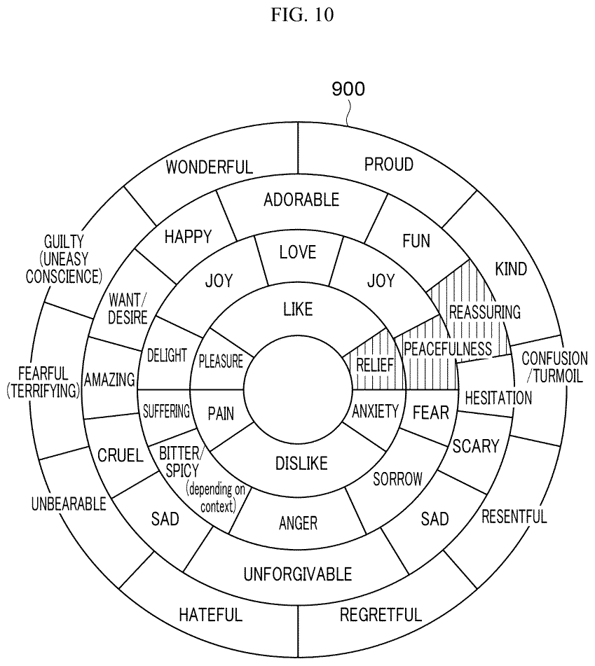

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
collect past competition information and behavioral characteristics related to a real-world high-skill individual via information acquisition processing and data analysis processing over a communication network, and store the collected competition information and behavioral characteristics as structured data in a storage device,
train, on the basis of the structured data stored in the storage device, a generative AI model that receives board-game state information and the behavioral characteristics as input and outputs move distributions and evaluation values, by using a machine learning framework and computation resources, and hold the generative AI model in a state usable as an opponent that imitates a strategy and a thinking pattern of the high-skill individual in a board-type game,
control a terminal device to generate, on a display device, a game screen for the board-type game, and receive operation input on the game state and character-string input from a user, receive, from the terminal device via a communication path, style instruction information including a prompt sentence input by the user to instruct the generative AI model to adopt a playing style or strategic tendency of a specific high-skill individual, together with current game state information,
convert the prompt sentence included in the style instruction information into numerical style information by text embedding processing or keyword extraction processing, generate model input data by integrating the numerical style information with the current game state information, and input the model input data to the generative AI model so as to generate a move, among legal moves, corresponding to the instructed style,
transmit, to the terminal device, response data including the move generated by the generative AI model and explanation text indicating a reason for selection of the move, and cause the terminal device to reflect the move on the game screen and to display the explanation text,
store user moves, moves of the generative AI model, the prompt sentence, the game state information, and a game result as battle history data in the storage device, and analyze the battle history data by using an evaluation function or an external analysis engine, classify each move into an excellent move, a poor move, or a clever move on the basis of a change in an evaluation value for each move, and generate and output feedback information for the high-skill individual based on a result of the classification.

### (Supplementary 2)

The system according to supplementary 1,
wherein the processor is configured to execute a learning process that updates parameters or style representations of the generative AI model on the basis of the battle history data and the feedback information, and dynamically adjusts a playing style reflecting the behavioral characteristics of the high-skill individual.

### (Supplementary 3)

The system according to supplementary 1,
wherein the processor is configured to select, in accordance with a game-type instruction, a difficulty-level instruction, or a strategy instruction included in the prompt sentence acquired from the user, a model or a model configuration corresponding to a target game from among a plurality of generative AI models, and change a move generation policy so as to deploy a strategy suitable for the target game.

### Application Example 1

### (Supplementary 1)

A system comprising a processor,
wherein the processor is configured to
acquire historical play information including past match information and behavioral characteristics of a skilled player, preprocess the historical play information, and convert the historical play information into a training data set including feature information for each skilled player,
train a generative AI model by using the training data set as input, and construct a match-generating generative AI model that imitates the behavioral characteristics of the skilled player,
receive a match start request and a game type designation from a user via a terminal, select the match-generating generative AI model based on the match start request and the game type designation, initialize state management processing that manages a game-state representation corresponding to the game type, and start a match,
receive user move information sequentially transmitted from the terminal, determine validity of the user move information based on the state management processing, and update state information based on valid user move information,
generate a prompt sentence by using updated state information, move history information, and condition information related to the behavioral characteristics of the skilled player as input to the match-generating generative AI model, and cause the match-generating generative AI model to generate a response move as an opponent move based on the prompt sentence,
calculate evaluation information related to the response move by inputting the state information and the move history information into an evaluation model or evaluation processing, and obtain an evaluation value related to advantage and disadvantage of each user move
generate, based on the evaluation value and analysis input information including the move history information, a prompt sentence for generating feedback information including an explanation of match content and improvement suggestions for the user, and cause a generative AI model to generate analysis results in natural language based on the prompt sentence,
output the analysis results to the terminal, and cause the terminal to display the analysis results and corresponding state information in response to a reference operation for each game state by the user, and
store match data obtained from a plurality of matches with the user, and update an internal parameter or a behavioral characteristic representation of the match-generating generative AI model based on the stored match data and new historical play information of the skilled player.

### (Supplementary 2)

The system according to supplementary 1,
wherein the processor is configured to
perform emotion estimation processing by using behavioral information or biological information acquired from the terminal as input in order to estimate an emotional state of the user, and dynamically adjust at least one of contents of the prompt sentence given to the match-generating generative AI model, selection criteria of the response move, and difficulty of the match based on a result of the emotion estimation processing.

### (Supplementary 3)

The system according to supplementary 1,
wherein the processor is configured to
generate a prompt sentence including condition information that defines a strategy policy and an explanation style to be deployed by the match-generating generative AI model in accordance with the game type selected by the user and a type of the skilled player, and control the match-generating generative AI model such that the match-generating generative AI model automatically deploys a strategy adapted to the selected game type based on the prompt sentence.

### Example 2

### (Supplementary 1)

A system comprising a processor,
wherein the processor is configured to
acquire, from an external information providing apparatus, information concerning past match records and personality characteristics of a real-world expert player, and store the acquired information as structured information in an information storage apparatus, preprocess the information concerning the past match records and the personality characteristics stored in the information storage apparatus, train a generative artificial intelligence model on a matrix computation apparatus using the preprocessed information, generate, as an inference model, a model that imitates a play style of the expert player, and deploy the inference model to an inference execution environment,
generate, based on a match start request and information indicating a type of a competitive game received from a terminal apparatus, a match session, and transmit session identification information and initial position information to the terminal apparatus,
update a current game position based on instruction information indicating a user turn and the session identification information received from the terminal apparatus, convert the current game position into an input format of the inference model, calculate a probability distribution of candidate next moves by using the inference model, determine a next move as an opponent move based on the probability distribution, and transmit the determined next move and updated position information to the terminal apparatus,
store, in the information storage apparatus, sequence information of all moves, match result information, and time information generated in accordance with progress of the match session, input stored match data into an analysis evaluation program, classify each move into at least one of an excellent move, an inferior move, and a ingenious move based on an evaluation value, and generate evaluation information including a classification result, aggregate the evaluation information into a format presentable to the expert player, and output, as feedback information, the evaluation information including statistical information indicating characteristics of the play style of the expert player and improvement candidate information, and
provide, in accordance with a user selection, the evaluation information to the terminal apparatus, and cause generation of a review display screen by which the user is enabled to view each move of the match and the evaluation thereof on the terminal apparatus.

### (Supplementary 2)

The system according to supplementary 1,
wherein the processor is configured to
update training information for the generative artificial intelligence model based on a match result produced by the inference model and a classification result of each move generated by the analysis evaluation program, and readjust parameters of the generative artificial intelligence model so as to sequentially update a play style reflecting the personality characteristics of the expert player.

### (Supplementary 3)

The system according to supplementary 1,
wherein the processor is configured to
switch inference conditions and behavior policies of the generative artificial intelligence model based on game type information, difficulty information, and desired condition information regarding opponent personality characteristics, which are input by the user via the terminal apparatus, and change a strategy pattern used by the inference model for each match session.

### Application Example 2

### (Supplementary 1)

A system comprising a processor and a storage device,
wherein the processor is configured to
acquire, from the storage device or an external information source, past match history information of multiple players and behavior tendency information derived from the past match history information, the past match history information and the behavior tendency information being obtained through an information terminal operated by a user, normalize the past match history information, extract feature information from the normalized past match history information, and generate a training data set based on the feature information, and store the training data set in the storage device,
and
train a generative artificial intelligence model by applying a machine learning algorithm to the training data set so that internal parameters of the generative artificial intelligence model are set to constitute a match opponent model capable of generating match behavior output reflecting the behavior tendency information,
and
generate a prompt sentence including an instruction that the match opponent model perform match behavior that imitates the behavior tendency information and generate explanation information, and input the prompt sentence to the generative artificial intelligence model so as to control behavior of the match opponent model during a match,
and
acquire a match start instruction and game type information input by the user from a match user interface executed on the information terminal, select the match opponent model according to the game type information, generate a prompt sentence including an instruction to start a match with the selected match opponent model, input the prompt sentence to the generative artificial intelligence model, and thereby cause a match between the user and the match opponent model to be started,
and
acquire image data and audio data of the user from an imaging device and an audio acquisition device provided in the information terminal, perform emotion estimation processing based on the image data and the audio data, and identify an emotional state of the user,
and
store setting information in which a match difficulty level and a behavior pattern of the match opponent model are associated with the emotional state, determine, on the basis of the emotional state, the match difficulty level and the behavior pattern as current setting information, change inference conditions or search conditions of the match opponent model in accordance with the current setting information, generate a prompt sentence including an instruction that the generative artificial intelligence model cause the match opponent model to adopt a match difficulty level and a behavior pattern reflecting the current setting information, and input the prompt sentence to the generative artificial intelligence model so as to dynamically adjust match behavior of the match opponent model,
and
acquire, during the match between the user and the match opponent model, position information of a current match situation and turn information of the user, which are transmitted from the information terminal, calculate, by using the match opponent model, response move candidates and evaluation information for the current match situation, select, based on a predetermined evaluation criterion, one of the response move candidates as a response move, output the response move to the information terminal as a match move of the match opponent model, and generate explanation information based on the evaluation information and output the explanation information to the information terminal,
and
after completion of the match, perform analysis processing on match history data including the position information of the match situation and moves in the match, classify, for each move of the user, a good move, an inappropriate move, and a clever move based on a change amount of an evaluation value, generate feedback information based on a classification result, and output the feedback information to the information terminal,
and
accumulate the match history data and the feedback information in the storage device, and update at least one of the internal parameters of the match opponent model and generation conditions of the prompt sentence, based on match results between the match opponent model and a plurality of users, so as to continuously improve match behavior reflecting the behavior tendency information.

### (Supplementary 2)

The system according to supplementary 1,
wherein the processor is configured to input the match history data, after completion of the match, into an analysis engine, classify moves of the user for respective positions based on a change in an evaluation value at each position, generate analysis results including the classification result and representative positions, generate, by using the generative artificial intelligence model, summary information that explains key points of the match, strengths of the user, and improvement points of the user, by generating a prompt sentence instructing the generative artificial intelligence model to generate the summary information and inputting the prompt sentence to the generative artificial intelligence model, and provide feedback including the summary information to the information terminal.

### (Supplementary 3)

The system according to supplementary 1,
wherein the processor is configured to, in response to selection information regarding a plurality of game types and a plurality of match opponent models acquired from the information terminal, generate a prompt sentence instructing the generative artificial intelligence model to set, in the match opponent model, a state representation format and a search policy suitable for a selected game type, input the prompt sentence to the generative artificial intelligence model, and thereby control the generative artificial intelligence model to perform, for each game type, an appropriate strategy deployment.

What is claimed is:

1. A system comprising:
circuitry configured to:
receive, via a communication interface coupled to a packet-switched network, competition information and behavioral characteristics associated with high-skill individuals, convert the competition information into structured data, and store the structured data in a storage device;
train, based on the structured data, a generative neural network model that receives game state information and style information as input and outputs move distributions and evaluation values, and hold the trained generative neural network model in a state usable as an opponent;
receive, from a terminal device via the communication interface, style instruction information including a prompt sentence and current game state information, convert the prompt sentence into numerical style information by text embedding processing, generate model input data by integrating the numerical style information with the current game state information, and execute inference processing using the generative neural network model with the model input data as input to generate a move among legal moves;
transmit, to the terminal device via the communication interface, response data including the generated move and explanation text indicating a reason for selection of the generated move; and
store user moves, model moves, prompt sentences, game state information, and game results as battle history data in the storage device, analyze the battle history data to classify each move based on changes in evaluation values, and update parameters of the generative neural network model based on the battle history data and classification results.

2. The system according to claim 1, wherein the circuitry is configured to collect the competition information and the behavioral characteristics via a communication network and apply data analysis processing to convert the collected information into the structured data prior to training.

3. The system according to claim 2, wherein the circuitry is configured to perform the data analysis processing by extracting at least one of strategic tendency features, move frequency distributions, and positional evaluation patterns from the competition information.

4. The system according to claim 3, wherein the circuitry is configured to generate the structured data comprising a plurality of records each associating game state information with a corresponding move, evaluation value, and behavioral characteristic label.

5. The system according to claim 4, wherein the circuitry is configured to train the generative neural network model using the structured data by applying a machine learning framework to minimize a training loss computed based on differences between predicted move distributions and ground-truth moves in the structured data.

6. The system according to claim 5, wherein the circuitry is configured to update model parameters by performing additional training using the battle history data accumulated during interactions with the terminal device, to adapt the generative neural network model to new competition information.

7. The system according to claim 1, wherein the circuitry is configured to convert the prompt sentence into the numerical style information by applying a text embedding model to generate a vector representation of the prompt sentence.

8. The system according to claim 7, wherein the circuitry is configured to generate the model input data by concatenating the vector representation of the prompt sentence with a feature vector derived from the current game state information.

9. The system according to claim 8, wherein the circuitry is configured to generate the explanation text by executing a secondary inference operation on the generative neural network model conditioned on the generated move and the model input data.

10. The system according to claim 1, wherein the circuitry is configured to analyze the battle history data using an evaluation function to classify each move as at least one of an excellent move, a poor move, or a clever move based on changes in evaluation values before and after the move.

11. The system according to claim 10, wherein the circuitry is configured to selectively update style representations in the generative neural network model using moves classified as excellent moves and clever moves, and exclude moves classified as poor moves from style representation updates.

12. The system according to claim 1, wherein the circuitry is configured to detect an affective state of the user based on operation input received from the terminal device, and dynamically adjust at least one of a difficulty level parameter and a style tendency parameter in the model input data in accordance with the detected affective state.

13. The system according to claim 12, wherein the circuitry is configured to modify the prompt sentence to include an affective state parameter, and regenerate the numerical style information by re-applying the text embedding model to the modified prompt sentence.

14. The system according to claim 1, wherein the circuitry is configured to store the battle history data in the storage device and perform a similarity search on stored game state records to retrieve prior moves having similar game states for inclusion in the explanation text.

15. The system according to claim 14, wherein the circuitry is configured to compute a similarity score between a vector representation of the current game state information and vector representations of stored game state records, and retrieve records having similarity scores exceeding a threshold value.

16. The system according to claim 1, wherein the circuitry is configured to receive character-string input from the user via the terminal device specifying a desired opponent persona, and generate the prompt sentence based on the character-string input for input to the generative neural network model.

17. The system according to claim 16, wherein the circuitry is configured to present the generated move and explanation text to the user on a game screen rendered on a display device of the terminal device.

18. A system comprising:
circuitry configured to:
train, based on structured data derived from competition information and behavioral characteristics of high-skill individuals, a generative neural network model that receives game state information and style information as input and outputs move distributions and evaluation values;
receive, from a terminal device via a communication interface coupled to a packet-switched network, a prompt sentence and current game state information, apply a text embedding model to the prompt sentence to generate a vector representation constituting numerical style information, and generate model input data by integrating the numerical style information with a feature vector derived from the current game state information;
execute inference processing using the generative neural network model with the model input data as input to generate a move among legal moves, and transmit response data comprising the generated move and explanation text to the terminal device via the communication interface; and
store user moves, model moves, prompt sentences, game state information, and game results as battle history data in a storage device, classify each stored move based on evaluation value changes using an evaluation function, and update model parameters of the generative neural network model based on the battle history data and classification results.

19. The system according to claim 18, wherein the circuitry is configured to detect an affective state of the user from operation input received from the terminal device, and adjust at least one of a difficulty level parameter and a style tendency parameter in the model input data based on the detected affective state.

20. A method comprising:
receiving, via a communication interface coupled to a packet-switched network, competition information and behavioral characteristics associated with high-skill individuals, converting the competition information into structured data, and storing the structured data in a storage device;
training, based on the structured data, a generative neural network model that receives game state information and style information as input and outputs move distributions and evaluation values, and holding the trained generative neural network model in a state usable as an opponent;
receiving, from a terminal device via the communication interface, style instruction information including a prompt sentence and current game state information, converting the prompt sentence into numerical style information by text embedding processing, generating model input data by integrating the numerical style information with the current game state information, and executing inference processing using the generative neural network model with the model input data as input to generate a move among legal moves;
transmitting, to the terminal device via the communication interface, response data including the generated move and explanation text indicating a reason for selection of the generated move; and
storing user moves, model moves, prompt sentences, game state information, and game results as battle history data in the storage device, analyzing the battle history data to classify each move based on changes in evaluation values, and updating parameters of the generative neural network model based on the battle history data and classification results.
